(19) United States
(12) Patent Application Publication
(10) Pub. No.: US 2024/0265317 A1
(43) Pub. Date: Aug. 8, 2024

(54) Systems, Methods and Processes for Scaffolding Coordination Conversations

(71) Applicant: Coo-e LLC, New Brunswick, NJ (US)

(72) Inventors: Quentin Jones, Highland Park, NJ (US); Richard P. Schuler, East Rutherford, NJ (US); Kevin Brandi, Egg Harbor, NJ (US); Douglas Gainous, Oswego, IL (US)

(73) Assignee: Coo-e LLC, New Brunswick, NJ (US)

(21) Appl. No.: 18/638,196

(22) Filed: Apr. 17, 2024

Related U.S. Application Data
(63) Continuation of application No. 16/393,631, filed on Apr. 24, 2019, now abandoned.
Application No. 16/393,631 is a continuation-in-part of application No. 16/136,461, filed on Sep. 20, 2018, now abandoned.
Application No. 16/136,461 is a division of application No. 14/019,320, filed on Sep. 5, 2013, now abandoned.

(51) Int. Cl. G06Q 10/0631; G06Q 50/00

(52) U.S. Cl. CPC G06Q 10/06311; G06Q 50/01

(57) ABSTRACT

Provided is a system and method for enhanced data collection and management for coordinating communications relating to social group activities, which includes generating a graphical user interface to be displayed to a plurality of users involved in communications for a social group activity, and generating an input for allowing a user to select one of a plurality of modes for determining a proposed start time of the activity. A first mode enables each user to generate one or more proposed start times. In a second mode, the user selects a date and condition comprising a minimum number of users with overlapping times of availability to attend the social group activity, wherein each user indicates their time availability during the selected date. A third mode enables the user to generate a poll proposing one or more dates for the social group activity, each date comprising one or more proposed times.

### RELATED APPLICATIONS

This application is a continuation of, and claims benefit of priority to, U.S. patent application Ser. No. 16/393,631 filed on Apr. 24, 2019, which is a continuation-in-part of U.S. patent application Ser. No. 16/136,461 filed on Sep. 20, 2018, which is a divisional application of and claims priority to U.S. patent application Ser. No. 14/019,320 filed Sep. 5, 2013, the entire disclosures of which are all expressly incorporated herein by reference.

### TECHNICAL FIELD

The present disclosure relates to systems, tools, methods and processes that support social activity coordination, by scaffolding social group-activity coordination conversations. It builds on research and development conducted by the inventors in domains of computer supported cooperative work (CSCW), Human Computer Interaction (HCl), mobile social computing and recommendation systems.

### BACKGROUND TO THE INVENTION

One of the primary uses of interpersonal communication technologies such as texting, instant messaging (IM) and mobile phone conversations is to coordinate social activities, such as the planning of a movie night out with friends, or a wine tasting, etc. Various papers have estimated that from 32 to 64 percent of SMS text messages (Grinter and Eldridge 2003; Ling 2005; Schiano et al. 2007) are for social coordination purposes. Battestini et al. (2010) found that 32% were “conversations were related to planning future events/get-togethers, coordinating around meal times, and organizing rides”; Ling (2005) found that 33% of messages pertained to “making agreements for activities that had not already started and were to take place within the next few days”; Grinter and Eldridge (2003) found that 51% of messages were used to arrange activities such as “as going to the pub, seeing a film, meeting at the cinema, and getting tickets for a club.” Early studies of IM (Nardi et al. 2000) found a similar pattern to text messaging (Battestini et al. 2010; Faulkner and Culwin 2005; Grinter and Eldridge 2001, 2003; Ling and Yttri 2002; Ling 2005) with a high proportion of messages being centered on social coordination.

The communicative processes used by people to manage future interactions (interactions about future interactions), is referred to as “outeraction”. (Nardi et al. 2000) While outeraction (coordination conversations) is often primarily conducted through mobile communication and is one of the main uses of mobile communication devices, existing mobile applications provide limited or ineffective outeraction-support. As a result, routine social-coordination is often associated with confusion about what decisions worked for each of the various participants, what details have been decided upon, who and how are people involved and how to manage basic attendance challenges (e.g. how to effectively communicate with group members about last minute changes of plans). As a result people lose a significant amount of time and expend a great deal of effort to coordinate everyday social activities.

The Language Action Perspective describes and facilitates the understanding of how people coordinate and helped guide the research and development of the disclosure. It (Winograd 1986, 1987) proposes that we view coordination from the perspective of coordination as “people act[ing] through language” and therefore coordination can be interpreted as different types of conversations that are comprised of individual language actions. This perspective is proposed as being in contrast to the more predominate perspective on coordination that it is about people processing information and making decisions. The authors' of Language Action Theory use the concept of a conversation to represent the “sequence of acts that can be interpreted as having linguistic meaning.” From this perspective it is not required to view a coordination conversation as solely spoken and/or written language it can also encompass actions that have shared and understood meaning, such as, forwarding an incoming call directly to voicemail.

Coordination Theory provides an understanding of what people coordinate for an activity to occur. Coordination Theory (Malone and Crowston 1990, 1994) views coordination as the process of managing dependencies. These dependencies are the “what” that people coordinate. The theory discusses examples of common coordination dependencies, such as, shared resources, tasks and subtasks, task assignments, etc. The theory proposes that if coordination is managing dependencies then in order to facilitate coordination it is necessary to understand and identify the different dependences and the processes that can be used to manage them (Malone and Crowston 1994).

Social coordination is required so that people to achieve a shared understanding. Common Ground theory (Clark et al. 1983), provides a means of describing and understanding this requirement. Common Ground is defined as the shared “mutual knowledge, beliefs, and suppositions” (Clark et al. 1983). The process of reaching common ground is termed grounding (Clark and Brennan 1991a). There are many different levels and types of common ground. For example, people who all watch the same TV show all share a common ground about the characters and events that they went through. At a higher level they also share some common knowledge about the genre that the show belongs too and at the highest level there is some shared understanding about TV shows in general. This shared knowledge and understanding is their common ground. Often some common ground may already pre-exist; however, it frequently needs to be developed and/or re-established via the grounding process. Successful grounding requires actors “to coordinate both the content and process” (Clark and Brennan 1991b). Grounding generally requires one of three steps: 1) a new contribution, 2) assertion of acceptance, or 3) request for clarification (Clark and Schaefer 1989). These steps may be repeated iteratively until all parties believe and/or acknowledge that they have achieved a common ground/shared understanding.

With the widespread and ever increasing adoption of Smartphones, the potential now exists to transform everyday social coordination through the systematic development of mobile outeraction-support systems—or put more simply, tools should exist that make social coordination an awful lot easier and in a manner that more closely resembles how it is carried out. However, until this invention, and despite more than 20 years of Computer Supported Cooperative Work (CSCW) System research into coordination processes, researchers and industry have yet to instantiate a mobile outeraction-support system that demonstrates a systematic understanding of the overall design space and provides outeraction-support that complements existing group norms for coordination. The invention described here alters this situation.

Currently, outeraction is predominately carried out through open communication channels (e.g., phone calls, emails, texts) which are occasionally complimented by the use of electronic calendaring (e.g., Google Calendar) and/or electronic invitation applications (e.g., evite.com, Google Calendar invite, Facebook Events). This often results in various members of coordinating group having distinct incomplete information about the state of coordination and activity details.

One approach to solving the scheduling challenges of social coordination is to have group members only share or vote on potential times when they would be willing to participate in an activity. In recent times such scheduling systems have gained popularity with business users (e.g., http://www.tungle.me/Home/and http://www.doodle.com/). These scheduling systems are generally seen as enhancements to calendaring systems. However, they still ignore the nuances of routine social coordination where there is no single optimum time for an activity, and individuals generally do not want to vote on a narrow set of choices. As a result, while these scheduling systems provide support for a narrow aspect of social coordination, such as—when the key issue is the availability of various individuals within a narrowly defined time period—they do not provide true outeraction support. To change this situation, calendaring/scheduling activities and the broader coordination conversations have to be intimately intertwined. This is because scheduling is only one aspect of activity coordination (Beard et al. 1990; Grudin 1994) and cannot generally be managed independently of other aspects. Grudin notes, meeting scheduling is a social task and has many underlying social implications unrelated to finding the most optimum time, it is “less an ‘optimizing’ task and more often a ‘satisficing’ task.” (Grudin 1994) In addition to the social implications there is the issue with the reliability of the data supplied to such systems. Blandford and Green (Blandford and Green 2001) found that “many users have developed the strategy of blocking out time for individual activities just so that they can control what meetings get booked.” They also identified various social issues that may arise, in particular, when a user “had set aside a contiguous chunk of time which they did not particular want to break, and yet to refuse a meeting at that time (when they are apparently ‘free’) would have appeared impolite.” (Blandford and Green 2001)

Similarly, there has been much research effort towards the development of automatic agent-based meeting scheduling systems and their respective electronic calendaring systems. An issue with the agent-based approach is that scheduling is only one aspect of social coordination and cannot generally be managed independently of other aspects. Meeting scheduling is a social task and has many underlying social implications unrelated to finding the most optimum time, it is “less an ‘optimizing’ task and more often a ‘satisficing’ task.” In addition to the social implications there is the issue with the reliability of the data supplied to such systems. Researchers have found that “many users have developed the strategy of blocking out time for individual activities just so that they can control what meetings get booked.” They also identified various social issues that may arise, in particular, when a user “had set aside a contiguous chunk of time which they did not particular want to break, and yet to refuse a meeting at that time (when they are apparently ‘free’) would have appeared impolite.” Moreover, similar to shared calendaring systems, many people are still wary of using agent-based systems to handle social coordination tasks.

Another method is “initiator or organizer-controlled event management,” such as, evite.com, Facebook Events, or a Google Calendar invite, where typically a single individual organizes an event and sends out an electronic invitation for an RSVP. This approach relies upon the event details being previously determined, and as a result restricts participants' ability to change coordinator roles, ignores the fluidity and lightweight nature of routine everyday social coordination (e.g., coordinating a lunch break, going to the movies), and does not effectively allow group members to gauge the group perspective in real time.

As calendaring/scheduling, agent and invitations systems generally support outeraction processes poorly, they have not become true alternatives to open communication technologies, and have not impacted significantly on everyday social coordination practices.

Previous research has also shown considerable social coordination difficulties often occur once the broad details of an activity have been decided. Key amongst these are problems and issues that develop while individuals are in transit to a chosen activity/destination and often additional coordination (outeraction) is required to make adjustments (e.g. dealing with a last minute change of venue). These adjustment processes have been called as rendezvousing (the near-synchronous mobile process of individuals organizing to meet at a specific place) (Colbert 2001) and micro-coordination (en route logistics, the end route discussion and negotiation of details as problems arise, and the negotiation of last minute meeting places) (Ling and Yttri 2002; Ling 2004, 2005). Many of the problems people faced when rendezvousing arise from previous phases in the coordination such as, incomplete or inaccurate details (e.g., where, or when), or uncertainty about who is actually expected to arrive (Schiano et al. 2007).

The lack of effective outeraction support for individuals engaged in group social coordination has implications for both consumers and businesses. Individuals engaged in coordinating routine social group-activities (being part of “coordination conversations”) often want highly targeted/relevant product and service information during the course of the coordination conversation that supports: 1) the decision making process (e.g. what activity should the group decide upon?); 2) the activity that is being coordinated (e.g. how can the group do what they are planning more cost effectively?) and 3) their personal engagement with the activity being coordinated (e.g. where can they buy a new ball on the way to the pickup game?). At present, individuals engaged in coordination conversations are typically served with adverts/recommendations (i) at the wrong time—e.g. a recommendation for a car purchase while coordinating a movie night with friends, or a recommendation for a discount to see a movie when the individual is not engaged in social activity coordination (ii) associated with the wrong location—e.g. an individual while coordinating a social outing with friends the following week in NY city, receives recommendations for the group near his current location in New Jersey; (iii) disconnected from social coordination—e.g. a luxury car advert is suggested to an individual in the process of coordinating a pickup soccer game with friends; and (iv) shown to the wrong group member—e.g. an individual invited by an organizer to go bowling but cannot attend, receives a coupon for a group ticket purchase but does not remember to pass on the information to the organizer so that the offer can be acted upon by the group. One of the reasons consumers engaged in social coordination are not presented with appropriate product/service information is that computer systems find it difficult to identify key aspects of the group coordination state, including: 1) that a group is engaged in a coordination conversation; 2) what a group coordination conversation is about; 3) what a group has decided about the activity over the course of the planning process; 4) where/when an activity is likely to occur; and 5) what sort of product service recommendation type would be relevant to the group at that particular stage in the coordination process. The failure of current systems to identify coordinating groups and their product/service needs means that businesses with relevant products and services struggle to engage such consumers with product/service recommendations.

An additional limitation of the approaches described above for coordinating social activities is that they do not support the coalescing of groups for ad hoc social activities where significant aspects are initially unknown. Currently, the coalescing of groups for social activities is dependent on an individual organizer/s taking the lead and deciding on the basic details of the activity in question and then advertising group and/or activity. For example, Meetup.com calls for an organizer/s to advertise a meetup group and set the times and locations for meetups and of course their associated Social Recommendation system recommends individuals to existing meetup groups.

### SUMMARY OF THE INVENTION

The present disclosure relates to a computer-based system, referred to herein as “Coo-e Coordinator,” that provides group communication and new methods, processes and techniques for the support social activity coordination. Coo-e Coordinator provides systematic outeraction support for the coordination of social group activities by providing a series of interconnected user-interfaces (UIs) and associated processes that effectively scaffold coordination conversation actions. Coo-e Coordinator scaffolds not only outeraction but also the broader social process of coalescing new a group for a social activity, social processes more broadly and provides overview and coordination-state/status information. A number of the new methods/processes/techniques can also be instantiated independently of the tool. One of the methods outlined, functions within the application as an activity-details suggestion management tool. It supports the management of both user-generated suggestions and product service recommendations. The tool also provides scaffolds for initial activity decision-making, micro-coordination and post social-activity interactions (beginning to end social-coordination support, often starting before the details are decided and extending until after the activity occurs). Tools, Methods and processes are also disclosed for the coalescing of groups for social activities.

The Coo-e Coordinator further provides a system and method for enhanced data collection and management of coordinating communications relating to social group activities. Specifically, the system generates a graphical user interface to be displayed to a plurality of users involved in communications relating to a social group activity and generates an input for allowing a user of the plurality of users to select one of a plurality of modes for determining a proposed start time of the social group activity. A first mode of the plurality of modes enables each of the plurality of users to generate one or more proposed start times and enables each user to select one of a plurality of voting buttons associated with each of the one or more proposed start times. The second mode enables the user to select a date and a condition comprising a minimum amount of users with overlapping times of availability to attend the social group activity, wherein each user of the plurality of users indicates their time availability during the selected date. A third mode of the plurality of modes enables the user to generating a poll propose one or more date for the social group activity, each date comprising one or more proposed times.

### BRIEF DESCRIPTION OF THE DRAWINGS

FIG. 1 depicts exemplary UIs of the TeeUp computational entity;

FIG. 2 depicts an exemplary embodiment featuring graphical element that both displays the group-coordination state—“It's On”, but also enables a user with the request permissions (typically the organizer) to change the group coordination state or phase of a particular TeeUp;

FIG. 3 depicts an exemplary embodiment in which the TeeUp UI can provide coordination conversation and state overviews for both simple and highly complex situations;

FIG. 4 depicts exemplary UIs, demonstrating how the TeeUp UI looks equivalent on multiple platforms;

FIG. 5 depicts yet another exemplary UI that includes a history of coordination conversation, including but on limited to the messages sent by participants, suggestions, likes or dislikes, changes in attendance status, etc. various graphical elements;

FIG. 6 depicts a still further exemplary UI that includes attendance status information such as the number invited, how many have stated that they are going;

FIG. 7 depicts another exemplary UI that includes an Activity-Detail Summary;

FIG. 8 depicts yet another exemplary UI that includes Suggestion Details, Participant Details and other summary information;

FIG. 9 depicts yet another exemplary UI that demonstrates how the global coordination state can be automatically changed when certain conditions are met including: (i) changing from Planning to It's On if a minimum number of participants say that they are going; (ii) Change from Planning or It's On to Happening if the game plan “when” is reached; (iii) moving from state from “Happening” to “It's Ended” the next calendar day if no duration information was provided for an activity;

FIG. 10 depicts yet another exemplary UI that demonstrates how organizers can limit and open the extent to which participants can change activity details including who will be participating, who can move items to the game plan, who can make an item on the game plan decided and who can modify game plan rows;

FIG. 11 depicts yet another exemplary UI that demonstrates the ability to allow users to determine the extent of activity decidedness that is required before information is placed in the users-personal calendar;

FIG. 12 depicts yet another exemplary UI that demonstrates the ability to allow individuals with the requisite permissions to modify the game plan rows;

FIG. 13 depicts yet another exemplary UI that demonstrates the ability to, in the process of suggesting a location for an activity, the user can receive a recommendation for a particular Cinema because of a discount;

FIG. 14 depicts yet another exemplary UI according to Illustrative Use Scenario 1;

FIG. 15 depicts yet another exemplary UI according to Illustrative Use Scenario 2;

FIG. 16 depicts yet another exemplary UI according to Illustrative Use Scenario 3;

FIG. 17 depicts yet another exemplary UI according to Illustrative Use Scenario 4;

FIG. 18 depicts yet another exemplary UI according to Illustrative Use Scenario 5;

FIG. 19 depicts yet another exemplary UI according to Illustrative Use Scenario 6;

FIG. 20 depicts yet another exemplary UI according to Illustrative Use Scenario 7;

FIG. 21 depicts yet another exemplary UI according to Illustrative Use Scenario 8;

FIG. 22 depicts yet another exemplary UI according to Illustrative Use Scenario 9;

FIG. 23 depicts yet another exemplary UI according to Illustrative Use Scenario 10;

FIGS. 24A-24C illustrate various “When” modes of the system of the present disclosure;

FIGS. 25A-25S illustrate the “SuggestWhen” mode of the system of the present disclosure;

FIGS. 26A-26P illustrate the “StartsWhen” mode of the system of the present disclosure;

and

FIGS. 27A-27Y illustrate the “WhenWorks” mode of the system of the present disclosure.

### DETAILED DESCRIPTION OF THE INVENTION

To provide social activity outeraction-support the present invention scaffolds the presentation of and associated language actions of the four main coordination components suggested by coordination theory (Malone and Crowston 1990, 1994). These are: “actors”, “activities”, “goals” and “interdependencies”. The “actors,” are an activity's organizer(s), participants, and invitees. The negotiation surrounding what, where and when collectively corresponds to the “activities”. The “goals” correspond to the aims of the organizers and other participants in the coordination process (invitees, attendees, etc.). For the coordination of a social activity, one of the main independencies is between who can or will come, at a particular time and/or location, for a particular activity. Routine language actions associated with each of these coordination components are scaffolded. For example; providing a button that allows a participant (an ‘actor’) to share that they are “interested” or they will be “going”; providing a button for making a suggestion for an ‘activity detail’ a preferred group outcome; helping the organizer reach the group “goals” by allowing him/her to set the system/tool to automatically change the displayed group-coordination state from “planning” to “it's on”, or to “it's happening” when various preconditions are meet (for example agreeing that a pickup volleyball game will only happen if 12 people agree to attend).

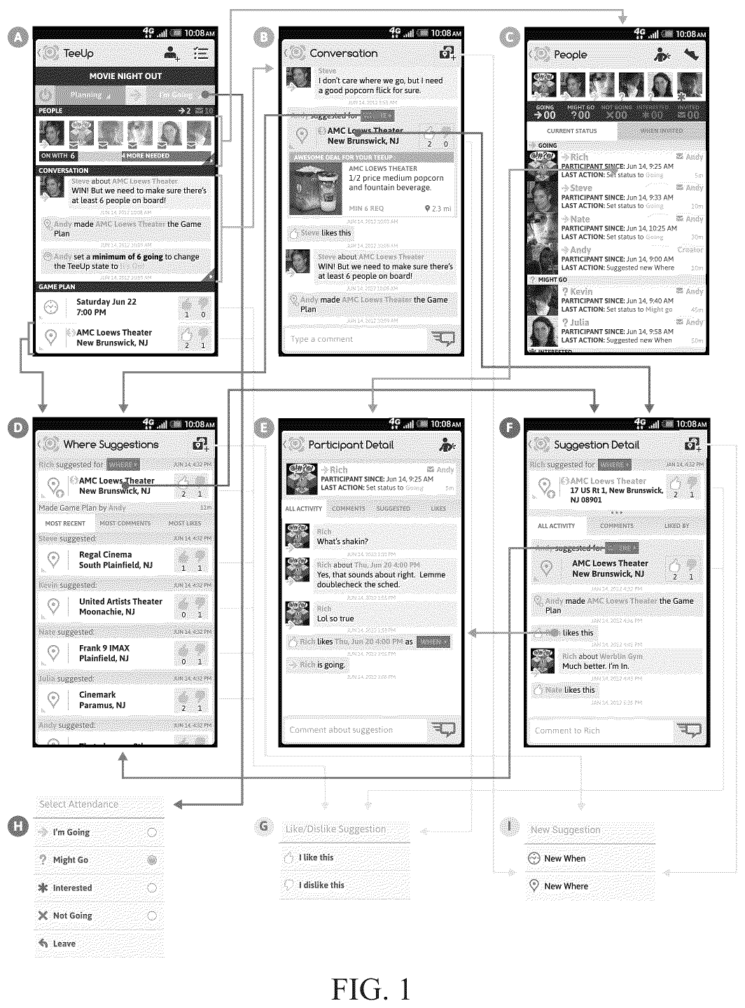

Much of the coordination-conversation scaffolding support that Coo-e Coordinator provides is through UIs, interaction methods and processes that are interconnected as a computational entity we refer to as a “TeeUp”. From a user perspective TeeUps can be considered a group coordination conversation. Key UIs of the TeeUp computational entity are shown in FIG. 1, as an illustrative embodiment of the present invention, which depicts user interfaces that comprises various graphical elements. Key UI and interaction components of the TeeUp include but are not limited to: 1) the main TeeUp UI (a subcomponent of the TeeUp computational entity) which provides a coordination-conversation overview and summary (FIG. 1, Image A); 2) a conversation screen that shows all the publically shared group actions of participants (if a user is going, messages, suggestions, etc.) (FIG. 1, Image B); 3) a people screen showing who is organizing the activity, who has been invited, who is attending, etc. (FIG. 1, Image C); 4) activity-detail summary view (e.g. when suggestions, when vote, when scheduling, where suggestions where vote, movie suggestions, cuisines suggestions, shared note) (FIG. 1, Image D); and 5) various details screens for individual participants (FIG. 1, Image E) and individual activity-suggestions (FIG. 1, Image F). These components and how they interrelate in terms of data displays and user interactions is illustrated in FIG. 1. Each of these UIs provides users with “quick actions” that help scaffold the coordination conversation (FIG. 1, Images G, H and I). For example, a user can (i) on the “game plan” area of the TeeUp UI, (ii) from the conversation screen, (iii) the activity-detail summary UI and (iv) suggest details screen quickly “like” or “dislike” an activity detail (FIG. 1, Image G) that is associated with a suggesting management process that involves liking or disliking an activity detail. Another example of a quick action is that users can quickly change their attendance state by a couple of button actions via the main TeeUp UI (FIG. 1, Image H). A third example of a quick action is that users from the conversation or suggestion summary view UI can quickly make a new scaffolded suggestion (FIG. 1, Image I).

The TeeUp computation entity not only consists of interconnected UIs, but also a state and data model that controls the display and scaffolded coordination conversation actions. The state model is comprised of the various entities that comprise the TeeUp, such as, the current global coordination state (e.g. Planning, It's on, Happening, Cancelled, Ended), the actors participating in the TeeUp, the various state the actors are in (e.g. Invited, Organizer, Going, Not Going, Interested, On My Way, Arrived), the different activity detail fields that actors may or may not have added to the TeeUp (such as when, where, shared note, shared list, etc.), the suggestions for the various fields (e.g. After soccer practice for When), the states the fields can be in (e.g. decided, undecided, withdrawn, on the game plan), the conversation history, and the messages. The state model of the TeeUp is responsible for tracking and managing the various changes that occur that may modify the data model. The data model is responsible for storing and retrieving the TeeUp data. The TeeUp state model and data model work together to provide a coordination conversation suggestion management system that allows for the management, coordination, and negotiation of the various details of coordinated activities. The state model is responsible for managing the consistency and integrity of the data model and for keeping all representations of the TeeUp in a consistent and known state. The data model is represented as a sequence of TeeUp state changes. Prior TeeUp states may determine future TeeUp states and the state model is responsible for accepting the transition between the different states. The state and data model of a TeeUp can be understood to a large degree from an understanding of the various TeeUp UIs. Therefore, this disclosure focuses on presenting the inventions through a description of various user interfaces.

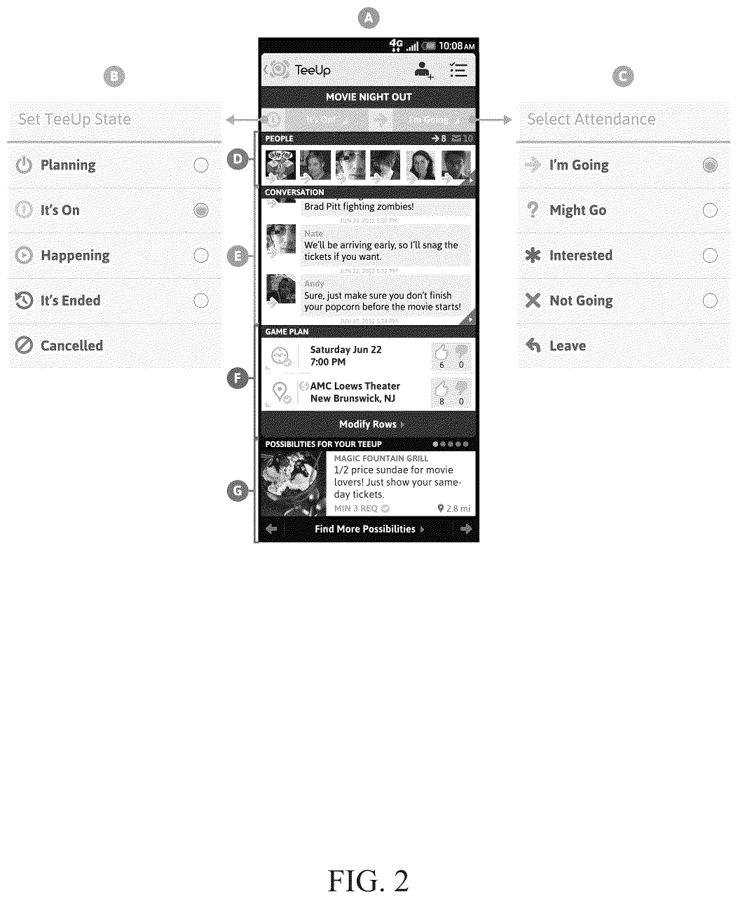

The TeeUp UI (one of many UIs associated with the TeeUp computational entity), in accordance with an illustrative embodiment of this component of the present invention will now be described with reference to FIG. 2 which depicts user interfaces that comprises various graphical elements.

The TeeUp depicted in FIG. 2 (-A) is titled by the users “Movie Night Out”, which typically represents the activity goal.

Below the title of the Tee-Up depicted in FIG. 2 is a graphical element that both displays the group-coordination state—“It's On”, but also enables a user with the request permissions (typically the organizer) to change the group coordination state or phase of a particular TeeUp. By invoking this graphical element, a menu is displayed to the user that comprises the following user-selectable states: “Planning,” “It's On!” “Happening,” “It's Ended”, and “Cancelled” (-B). The user interface depicted in the FIG. 2 (-C) also comprises a graphical element that also displays the user's current attendance state and enables a user to alter his/her attendance for a particular Tee-Up. By invoking this graphical element, a menu is displayed to the user that comprises the following user-selectable attendance states: “I'm Going,” “Might Go,” “Interested,” “Not Going,” “Leave,” “Confirm,” etc. In the illustrative embodiment, the user's attendance for the Tee-Up is set to “I'm Going.”

The people panel/area of Tee-Up depicted in FIG. 2 addresses the “actors” coordination component discussed above. In FIG. 2-D illustrative embodiment, this panel displays but is not limited to:
Basic attendance statistics, the nature of which is linked to the global state. For example, in the illustrative embodiment, 10 people have been invited, and 8 people have changed their attendance status to going. For example, in the illustrative embodiment, FIG. 2, there are a total of two people going to “Movie Night Out”;
Avatars of persons invited or involved in a particular Tee-Up. The current instantiation has this sorted with the individuals with the mostly recently changed attendance status appearing on the left. The most recent being the furthest to the left, the next most next to this avatar on the right.
Participants attendance state is superimposed on each person's avatar to indicate if they are going, might go, interested, not going, arrived, etc.;
Organizer avatars are also distinguished by an icon, the current embodiment provides the organizer with a crown.
This space also shows group state information such as a minimum number needed for an activity to be on bar (critical mass bar).

The conversation panel/area in the TeeUp depicted in FIG. 2-E is a peephole/porthole view into the full coordination conversation presented in through the conversation UI of the TeeUp computational entity. In the illustrative embodiment, for example, Andy says “Sure, just make sure you don't finish your popcorn before the movie starts”. The user navigates to the conversation UI of the TeeUp by acting on the conversation panel in the TeeUp.

The “Game Plan” panel/area in the TeeUp depicted in FIG. 2-F is an area of the TeeUp UI where participants in a TeeUp can indicate or summarize preferred activity details. These may represent a consensus view, the organizers view or a strongly preferred suggestion of a participant (this depends both on user-TeeUp permission settings and what types of rows and row modes are displayed on the Game Plan), or what the activity-details summary screen is referred to (e.g. Potluck Picnic List/Shared Note, Voting on When). In the illustrative embodiment, a person has moved the suggestion “Saturday June 22, 7:00 PM” onto the “Game Plan”. By invoking certain graphical elements displayed in the “Game Plan” panel, a person can suggest a new activity, replace a suggestion, withdraw the suggestion, etc. A person can also indicate whether he/she likes or dislikes a particular suggested activity detail, which indication is then presented in the “conversation” panel as part of the overall conversation.

The “recommendations” panel/area of the TeeUp UI depicted in FIG. 2-G below the game plan area displays recommendations typically in the form of coupons or other types of advertisements. These coupons and advertisements are targeted, unobtrusive, and relevant to the activity of the TeeUp. The coupons and advertisements presented are derived from an analysis of the coordination conversation and are targeted to meet the needs of the coordinating group. User can act on the coupon/advertisement so that it becomes embedded as a suggestion in the conversation linked to an activity detail, which may or may not be immediately displayed as a preferred action displayed on the “Game Plan”.

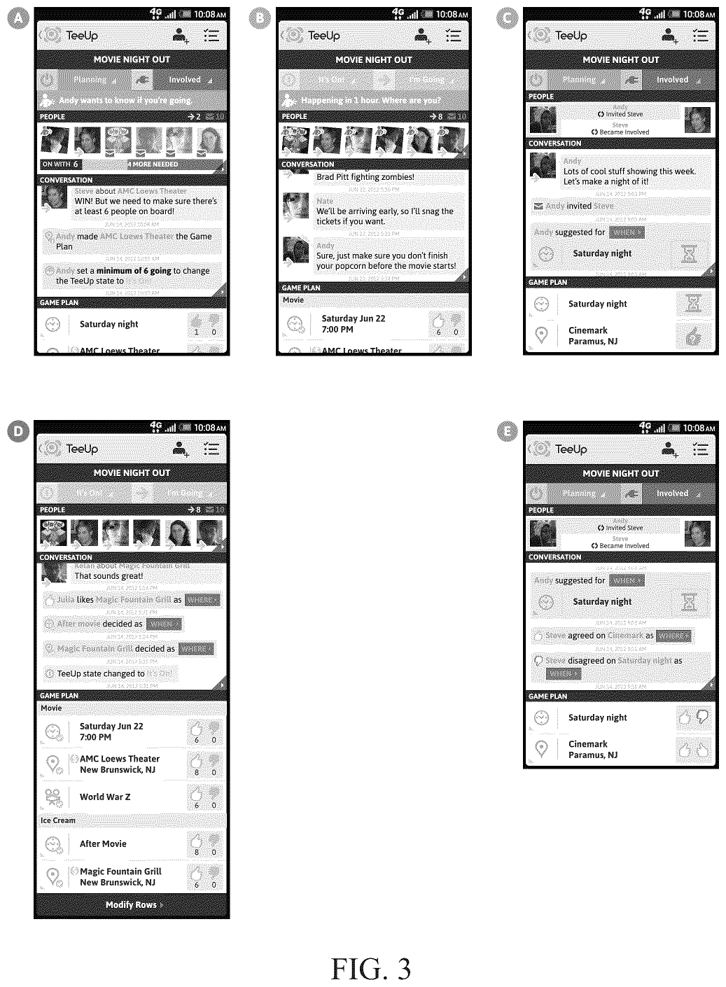

The FIG. 3 illustrates how the TeeUp UI can provide coordination conversation and state overviews for both simple and highly complex situations. FIG. 3-A—shows how the TeeUp UI looks to a user that has been nudged by another user. FIG. 3-B—shows how the TeeUp UI looks when a user is nudged by the system notifying that an activity is happening. A nudge prompts the user to act, typically to change their attendance state or to post a message. FIGS. 3-C and E shows how the people and game plan areas/panels are modified when there are only two participants (both participants act as organizers, different like/dislike options). FIG. 3-D shows a complex game plan where a coordinating group has planned to first see a movie and then get ice cream afterwards.

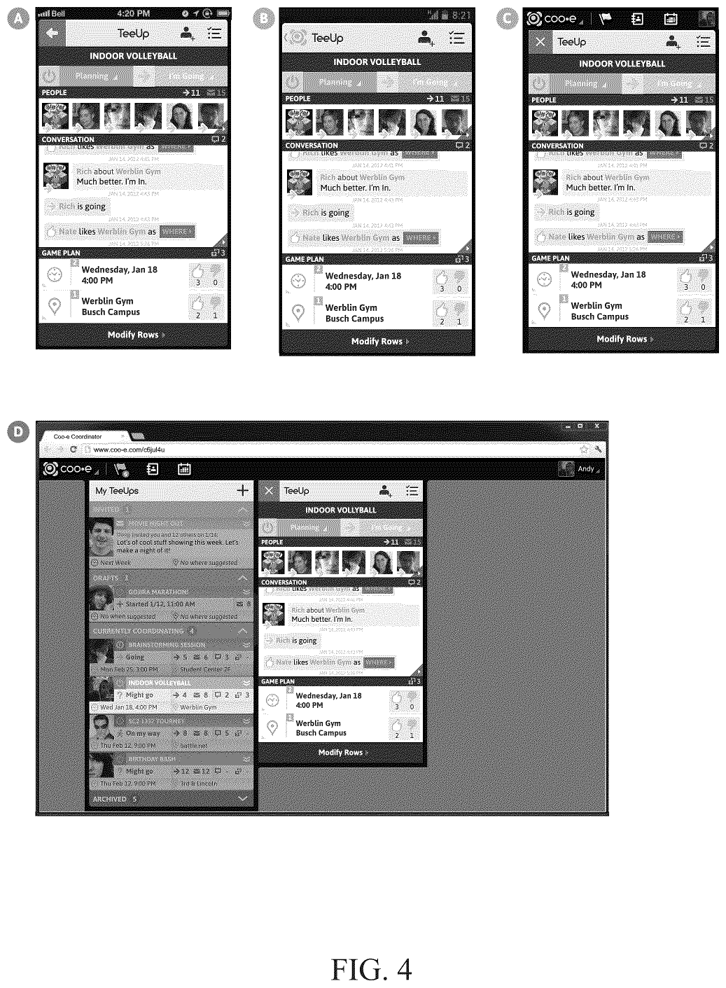

The FIG. 4 illustrates how the TeeUp UI by looking equivalent on multiple platforms helps individuals in a coordinating group achieve a shared understanding of the state of the coordination, grounds (Clark and Brennan 1991a) their interactions and helps them achieve common ground (Clark and Brennan 1991a; Clark 1996; Clark et al. 1983; Klein et al. 2005). FIG. 4A shows the iPhone version of a TeeUp, FIG. 4B the Android, FIG. 4C the mobile web, and FIG. 4D a desktop web version of the TeeUp.

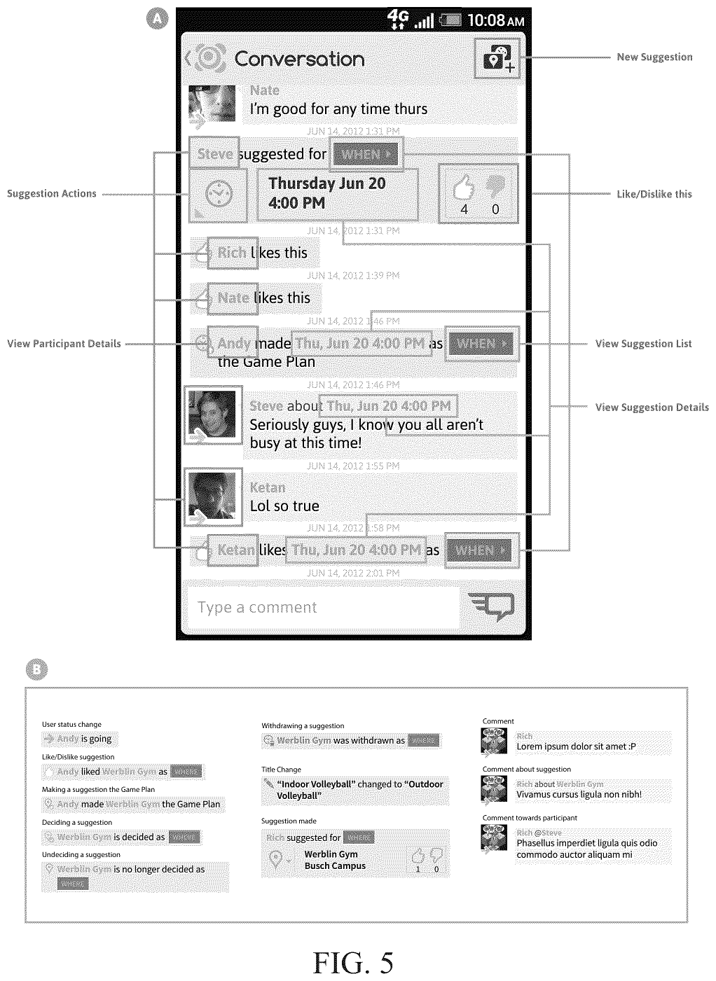

The “Conversation” UI of the TeeUp (the computational entity) in accordance with an illustrative embodiment of this component of the present invention will now be described with reference to FIG. 5 which depicts user interfaces that comprises various graphical elements. It provides a history of coordination conversation, including but on limited to the messages sent by participants, suggestions, likes or dislikes, changes in attendance status, etc. The FIG. 5 illustrates how the conversation is typically displayed showing a history of the coordination conversation and some of the scaffolded actions (“Quick Actions”) users can take using the conversation UI. These include making a new suggestion, making a comment to the group, liking or disliking an existing suggestion, acting on a suggestion, e.g. placing a suggestion on the game plan (where the user and suggestion has appropriate associated permissions) and navigating to the TeeUp UI, suggestion lists, suggestion details, and participant details. FIG. 5B provides a series of examples of items that can be posted to the conversation including changes in user status, user-like actions, making suggestions, appear on the game plan, etc.

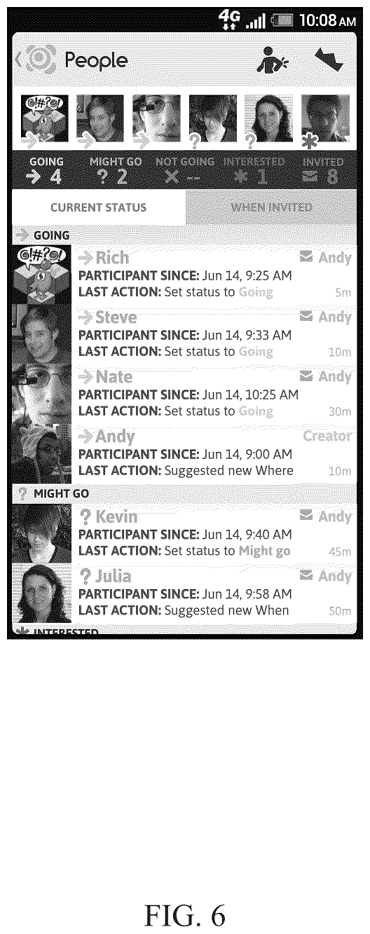

The People UI in accordance with an illustrative embodiment of this component of the present invention will now be described with reference to FIG. 6, which depicts a user interface that comprises various graphical elements. It provides attendance status information such as the number invited, how many have stated that they are going.

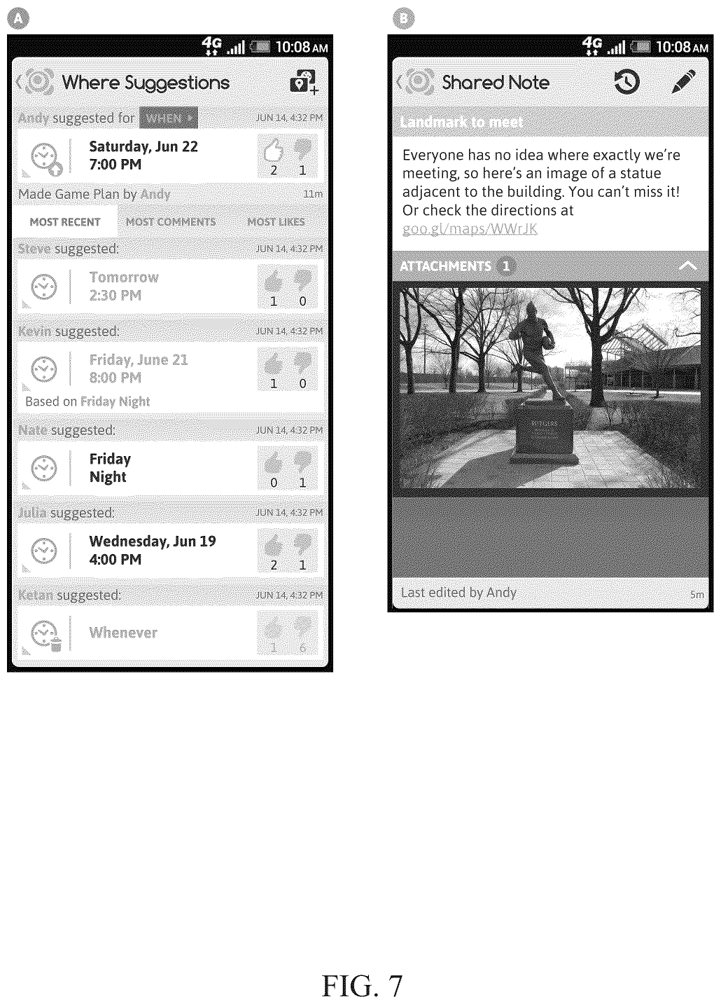

Activity-Detail Summary UIs in accordance with an illustrative embodiment of this component of the present invention will now be described with reference to FIG. 7 which depicts interfaces that comprises various graphical elements. It presents two examples (A and B) of Activity-Detail Summary UIs, FIG. 7A for when an activity might occur, FIG. 7B a shared note. FIG. 7-A shows that a suggestion has been moved to the game plan area of the TeeUp, that the details are as yet undecided and the extent to which various suggestions were liked/disliked by participants. It also shows that some of the suggestions were withdrawn. How activity-detail summary UIs function and display information depends on the mode of operation as defined by the TeeUp organizers. By default if an Activity-Detail is using the suggestion list approach shown, participants will be responsible for the movement of a particular suggestion to the game plan as is displayed on FIG. 7A. Other approaches are possible, for example an activity detail could potentially be decided through a one-user one-vote mode, or a time via a scheduling tool showing participant availability. Other modes include a shared note (FIG. 7B) and a shared list, which could for example be used by participants to outline who is bring what food item to a pot luck picnic.

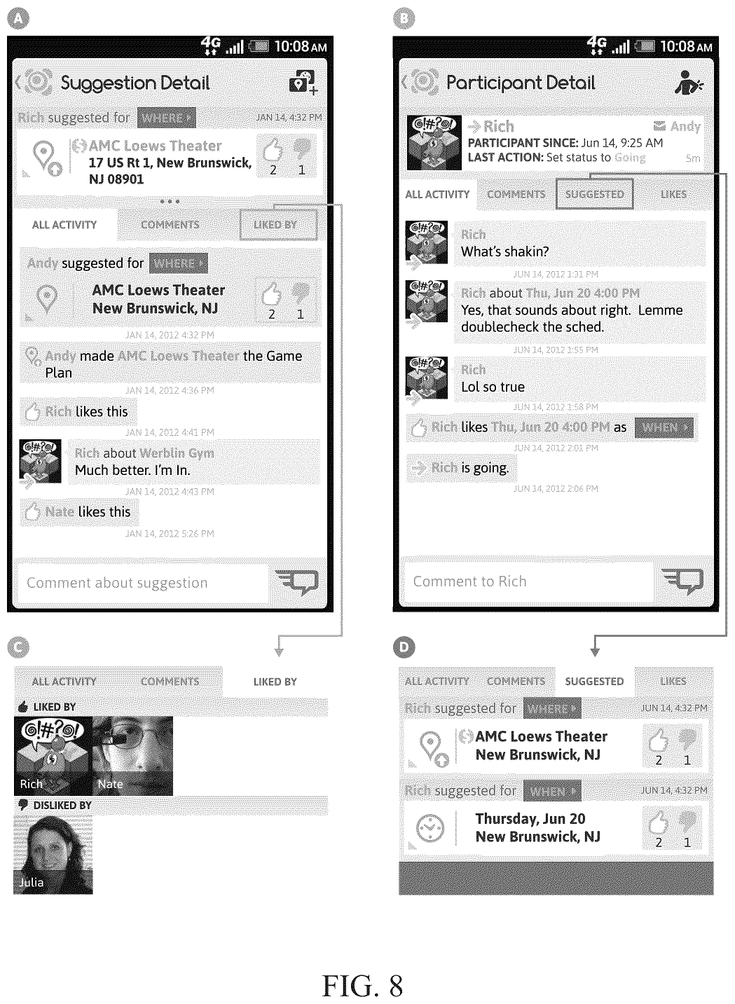

Details screens for individuals participants and suggestion UIs in accordance with an illustrative embodiment of this component of the present invention will now be described with reference to FIG. 8 which depicts user interfaces that comprises various graphical elements. FIG. 8 A shows a suggestion detail for when—it shows comments made about this suggestion, who liked/disliked the suggestion). FIG. 8B shows a participant detail—it shows comments that were directed towards this individual and their history of interactions within this particular TeeUp. The outeraction support provided by the suggestion details UI does not constrain open conversation (e.g. Flores et al. 1993 (U.S. Pat. No. 5,216,603)), rather it makes conversational actions easier. So for example, a participant can suggest that an activity occur “after the next soccer practice” (i.e. conversational English) or “January 23.sup.rd” (i.e. calendaring information). FIGS. 8-C and D show different details summary information can be presented.

The suggestions represent actor provided information that is negotiated and coordinated using the TeeUp. Each suggestion is linked to an actor specified field (activity-detail, such as when, where, movie, pot luck list) in the TeeUp and TeeUp UI. When a field/activity-detail is operating in suggestion mode, then the activity-detail summary UI lists all suggestions under that field together. A suggestion is comprised of actor provided data that is dependent upon the data type of the field that the suggestion is linked to. Along with the link to the field the suggestion is also associated with the actor that offered the suggestion and various states that the suggestion may be in. The suggestion UIs then provide a mechanism for the actors to construct shared artifacts that represent the set of suggestions for the various fields that are being coordinated and negotiated. These shared artifacts are a combination of the TeeUp state and data model along with the suggestion UIs.

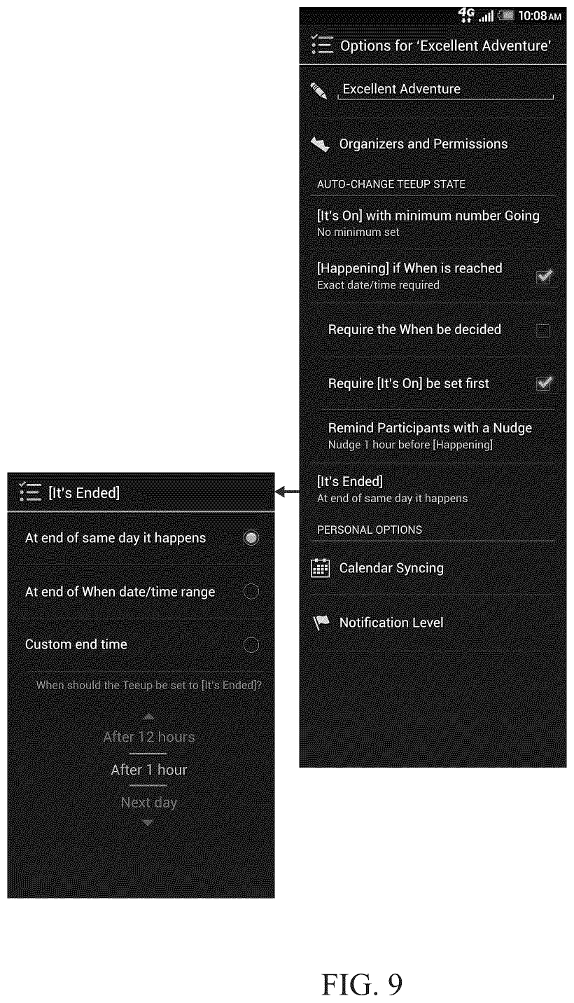

TeeUp Options UI in accordance with an illustrative embodiment of this component of the present invention will now be described with reference to FIG. 9, which depicts a user interface that comprises various graphical elements. It shows how the global coordination state can be automatically changed when certain conditions are met including: (i) changing from Planning to It's On if a minimum number of participants say that they are going; (ii) Change from Planning or It's On to Happening if the game plan “when” is reached; (iii) moving from state from “Happening” to “It's Ended” the next calendar day if no duration information was provided for an activity.

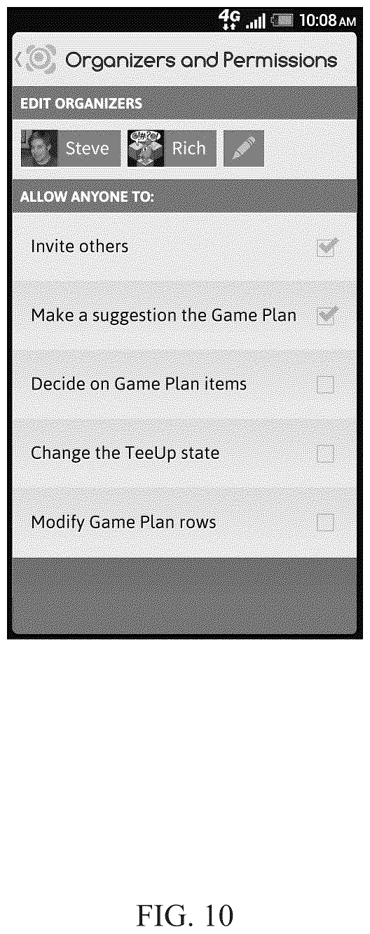

TeeUp Organizers and Permissions UI in accordance with an illustrative embodiment of this component of the present invention will now be described with reference to FIG. 10, which depicts a user interface that comprises various graphical elements. It illustrates how organizers can limit and open the extent to which participants can change activity details including who will be participating, who can move items to the game plan, who can make an item on the game plan decided and who can modify game plan rows. In this case only organizers can decide on game plan items, change the TeeUp state, or modify game plan rows.

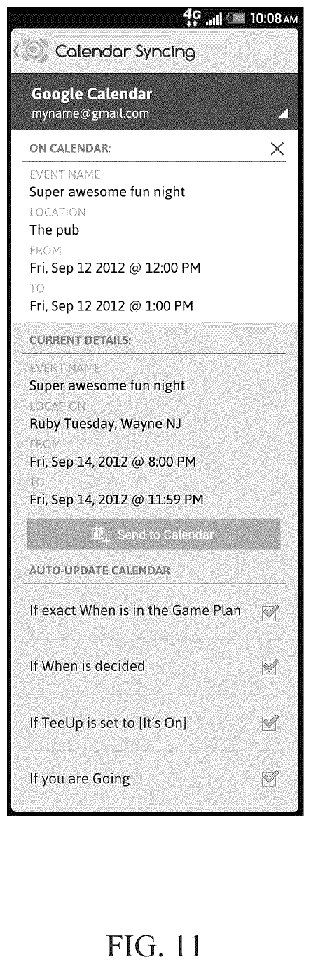

User-TeeUp Calendar Synching UI in accordance with an illustrative embodiment of this component of the present invention will now be described with reference to FIG. 11, which depicts a user interface that comprises various graphical elements. As coordination conversations are fluid and details often change coordinator allows users to determine the extent of activity decidedness that is required before information is placed in the users-personal calendar (e.g. Google calendar if Coordinator was being used on an Android phone). In the figure for a calendar update to occur an exact when is required on the game plan (e.g. 7 pm Monday the 22nd as opposed to after soccer practice), this information needs to be decided, the TeeUp needs to be considered “on” as opposed to being in planning mode, and the individual needs to confirm that they are going. In FIG. 11 calendar synching only occurs if the individual is going, the event is On/happening, and all the details are decided.

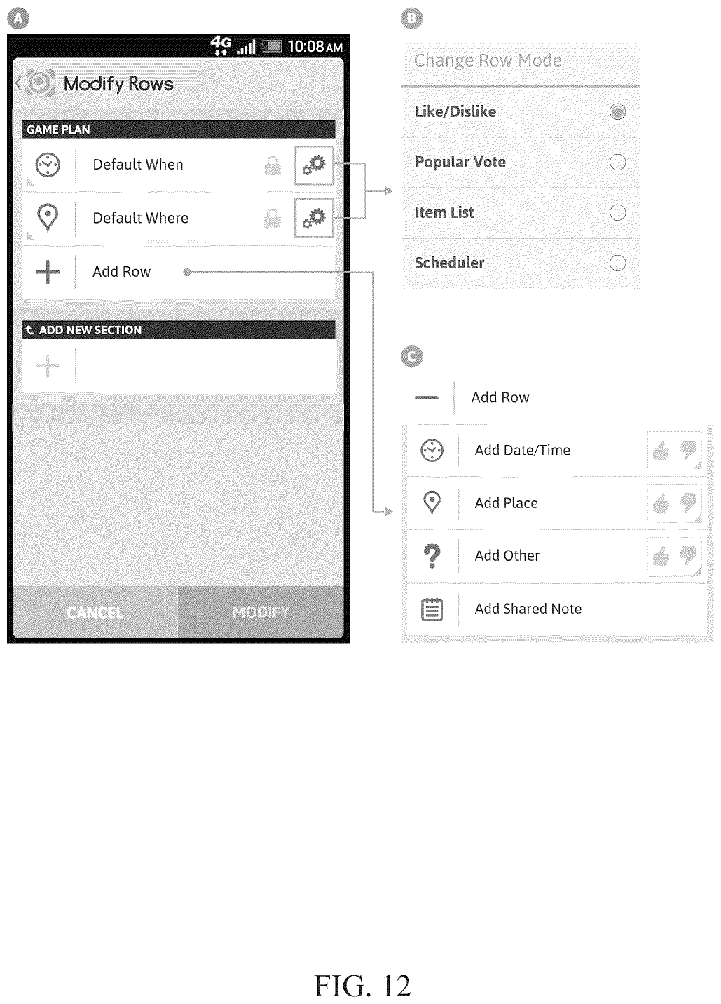

Game Plan Modify Row UIs in accordance with an illustrative embodiment of this component of the present invention will now be described with reference to FIG. 12 which depicts user interfaces that comprises various graphical elements. Below the Game Plan area of the TeeUp UI is a button that allows individuals with the requisite permissions to modify the game plan rows. These rows can be of various types, date, location, miscellaneous (presented as “other” to the user)—which are associated with various recommendation sets (e.g. a movie row—when used by the user can recommend to the user movies currently showing—using the context aware recommendation system), shared notes, etc. In FIG. 12 the default game plan is shown consisting of “When” and “Where” Rows and the basic row mode options. By default in the current instantiation a user controlled like/dislike suggestion list system is used for both the “When” and “Where” rows.

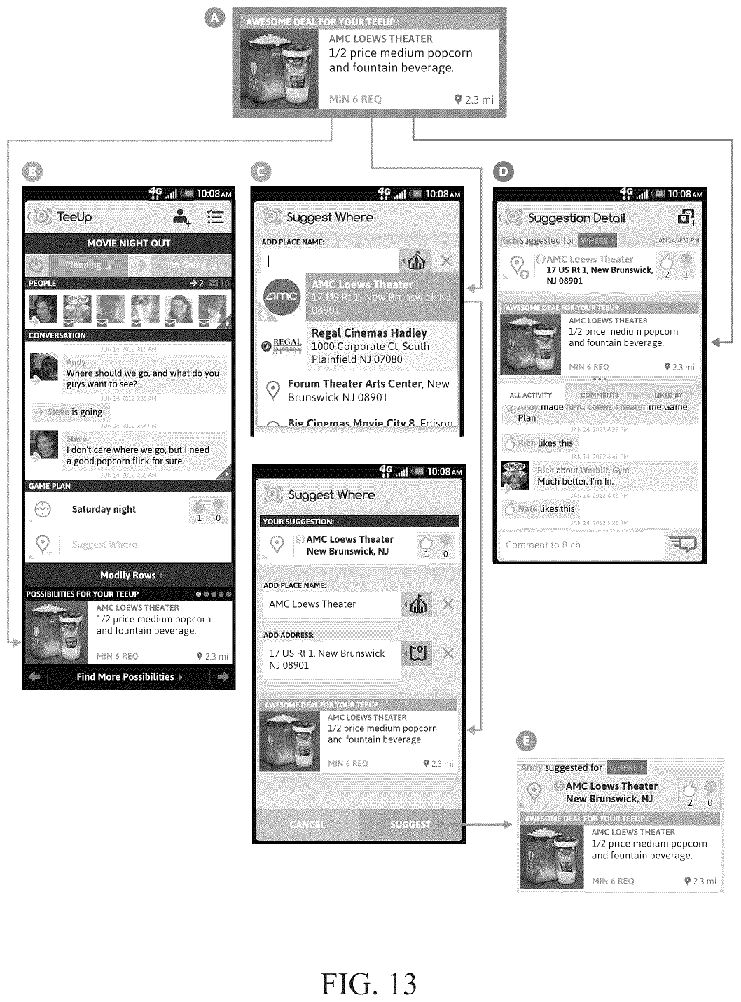

Product and Service Recommendations can be presented to participants on the TeeUp UI (in FIGS. 1 and 2 this is shown below the game plan area), when participants are making new suggestions, and on the game plan and in the conversation if a participant has decided to make a computer based recommendation part of the coordination conversation. Because the TeeUp encourages users to explicitly identify (i) that a social activity is being planned (that they are Tee-ing Up), (ii) what the activity is about (from the TeeUp title, conversation and game plan actions), [iii] where approximately it will occur (from conversation, game plan, suggestion lists, user locations, history of user-locations), [iv] when approximately an activity will occur (from conversation, game plan, suggestion lists, etc.); and the state of the coordination (e.g. planning, decided upon, happening, ended, cancelled) contextually relevant, highly targeted recommendations are possible. In addition, the system can recommend to users organizing for example a movie night out, additional game plan rows that makes coordination actions easier and helps groups achieve their coordination goals. In other words, the TeeUp provides a means for computerized identification of coordination state, which allows for highly targeted group recommendation support. Recommendations within TeeUps in accordance with an Illustrative embodiment of these components of the present invention will now be described with reference to FIG. 13 which depicts user interfaces that comprises various graphical elements. Here in the process of suggesting a location for an activity the user receives a recommendation for a particular Cinema because of a discount. FIG. 13A shows the recommendation, FIG. 13B shows this same recommendation below the game plan of a TeeUp, FIG. 13C when making a new suggestion, FIG. 13D who that recommendation appears as a suggestion by a user in the UI conversation, and FIG. 13E shows the view of the recommendation in the suggestion details area.

Providing relevant hyper-local recommendations to groups in the context of social activity coordination requires a solid understanding of what is being coordinated, which of course changes over time. Fortunately, the design of the TeeUp encourages users to provide us with the unique data needed to make recommendations targeted to a group of people engaged in social coordination (something that Facebook and Google are struggling to achieve). This is made feasible because of our ability to use the conversational data contained in the TeeUp to dynamically estimate the:
1) Activity Type—Early on during the coordination the system would be able to determine that the primary activity being coordinated is a ‘social movie watching’ based on the TeeUp title, conversation analysis of key words, and that the activity was planned for a weekend night;
2) Activity Time—This is possible once users start to make suggests for ‘when’;
3) Activity Locale—Initial estimates prior to participants suggesting locations can be made based on the general location of the participants, in this case in Northern New Jersey;
4) Decidedness of various Activities—TeeUps generally start with the global state being ‘Planning’, and, if successful, move to “It's On”, then “Happening”, and then “Its Ended” state (displayed in the Coordination State Bar). In addition, Game Plan items generally move from being empty, to being undecided, to finally being locked in as decided. Analysis of these states in combination with other conversational data allows for good estimates of the overall decidedness of TeeUp activities.
5) Using these estimates, we can then derive a recommendation set. For example, a list of social activities and venues that are open on a Saturday night with the highest rank value going to a movie venue that is in Northern NJ, which are further sorted by those nearest to Jersey City. Recommendation sets are to be provided by the local businesses along with their desired target audience and activity types as well as keywords that are associated with the recommendation. “Recommendation Presentations” are a set of modifications that can be applied to a recommendation that can increase its relevancy. The system can then apply the dynamic estimates to the recommendation set and the recommendation presentations that generates a set of recommendations that are relevant (e.g., recommending various movie theaters if the determined activity type is a movie) and modifying those recommendations by changing their presentation (e.g., theater decidedness is estimated as very high so suggest nearby ice-cream as something to do after the movie). FIG. 7 lays out the order of steps needed to derive such hyper-local recommendations.

From our previous work in recommendation-systems (Jones 2009 (U.S. patent App. Pub. No. 2009/0106040); Jones et al. 2011 (U.S. patent App. Pub. No. 2011/0191352); Mayer et al. 2010) and the state of the art of the community as a whole, it is possible using data from the TeeUp computational entity to build a system that presents desired recommendations to people coordinating social activities using a number of standard technics in the Natural Language Processing (NLP) and text mining/information retrieval fields to ensure robust estimation and confidence threshold measures. These include using keyword extraction from the small sentences paired with thesaurus lookup techniques, to categorize activity types into a Yellow Pages-type taxonomy such as the Standard Industry Classification (SIC) (Bohne et al. 2011; Li et al. 2008).

Coo-e Coordinator supports coalescing of groups through four interrelated processes: 1) enabling TeeUp organizers to make a TeeUp public/discoverable by the user-community and in the process creating a browser-able and searchable “activity marketplace”. As most social coordination is between known individuals, TeeUps are generally private in nature and only known of by organizers and those invited to participate; 2) supporting and encouraging users to profile their activity interests when searching or browsing the “activity marketplace”; 3) providing a privacy respecting means for those users who self-profile through searching or browsing the activity market to invite or receive invitation to TeeUp with others who have similar activity interests in a geographic area; and 4) providing computer initiated TeeUps that systematically coalesce interested parties into groupings that encourage collective action. Prior to this disclosure the coalescing of groups for social activities was dependent on an individual organizer/s taking the lead and deciding on the basic details of the activity in question and then advertising the group and/or activity. For example, Meetup.com as currently instantiated calls for an organizer/s to advertise a meetup group and set the times and locations for meetups and of course their associated Social Recommendation system recommends individuals to existing meetup groups.

User search of the Activity Market supports and encourages users to profile their activity interests by providing a visualization of the number of other individuals searched for the same or similar activities, informing the user that based on their search we have profiled them as interested in a particular activity, along with the ability to correct or remove this profiling information and the ability to be notified when a matching activity is created in the future or when number of other people have also searched unsuccessfully for an equivalent activity. This is achieved by search results displaying the total number of users that have searched for a particular activity, a validation option that queries the user as whether or not they are truly interested in the activity that they have just searched for, or whether it was searched for accidentally. The unique approach here is to allow those with shared interests to discover that they are not alone in their interests in a privacy respecting manner (personal details anonymized), by user's searching, browsing and TeeUp history being used to profile their interest, and then making available to users the number of other users are interested in said social activity, and enabling those with shared interests to be invited to a TeeUp that establishes activity details and allows collective action to occur. So instead of being limited to searching for an existing meetup, or meetup group that potentially is engaged in a social activity of interest, which requires an existing meetup organizer or for the searching individual to be willing to take on a leadership role, the approach disclosed here is to allow users who search successfully or unsuccessfully for an activity to have their interest in a particular type of social activity profiled, and when the system identifies that a critical mass of users with shared interests exist for an activity in a particular locale, it then invites interested parties to a TeeUp. Similarly, a user can decide to create a public TeeUp and invite those individuals with the shared interest to get involved.

In summary “Coo-e Coordinator” provides systematic outeraction support for the coordination of social group activities. Not only does the tool support individual user behavior through quick actions that makes it easier to state individual preferences (e.g. like/dislike) and states (e.g. going/not going) but also group action by allowing individual actions to move a group semi-automatically towards desired outcomes (e.g. changing the TeeUp state “planning” to “its on” when enough people state that they are going). By providing a unified computational structure (the TeeUp) centered on a coordination conversation overview (the TeeUp UI) that scaffolds the four main coordination components (i.e., “goals,” “activities,” “actors,” and “interdependencies”), the present invention is able to address many of the deficiencies of outeraction-support associated with open communication technologies, electronic calendaring, and electronic invitation applications discussed in the prior art. In addition, because the TeeUp encourages users to explicitly identify (i) that a social activity is being planned (They are Tee-ing Up), (ii) what the activity is about (from the TeeUp title, conversation and game plan actions), [iii] where approximately it will occur (from conversation, game plan, suggestion lists, user locations, history of user-locations), [iv] when approximately an activity will occur (from conversation, game plan, suggestion lists, etc.); and the state of the coordination (e.g. planning, decided upon, happening, ended, cancelled) highly targeted recommendations are possible. In other words, the TeeUp provides a means for computerized identification of coordination state, which allows for highly targeted group recommendations that can easily become part of a group's coordination conversation. This in turn allows consumers engaged in social coordination and businesses to interact in ways not considered possible until this disclosure.

### Illustrative Use Scenarios

How Coo-e Coordinator, the Tee-UP UI and associated functionality effectively scaffold the coordination conversation is illustrated through a series of coordination scenarios and associated detailed descriptions of the application functionality, and various supporting features. The scenarios are illustrative embodiment of the systems, methods, processes and techniques disclosed. The scenarios are enabled by the TeeUp computation entity that consists not only of interconnected UIs but also a state and data model and associated state change and data entry rules.

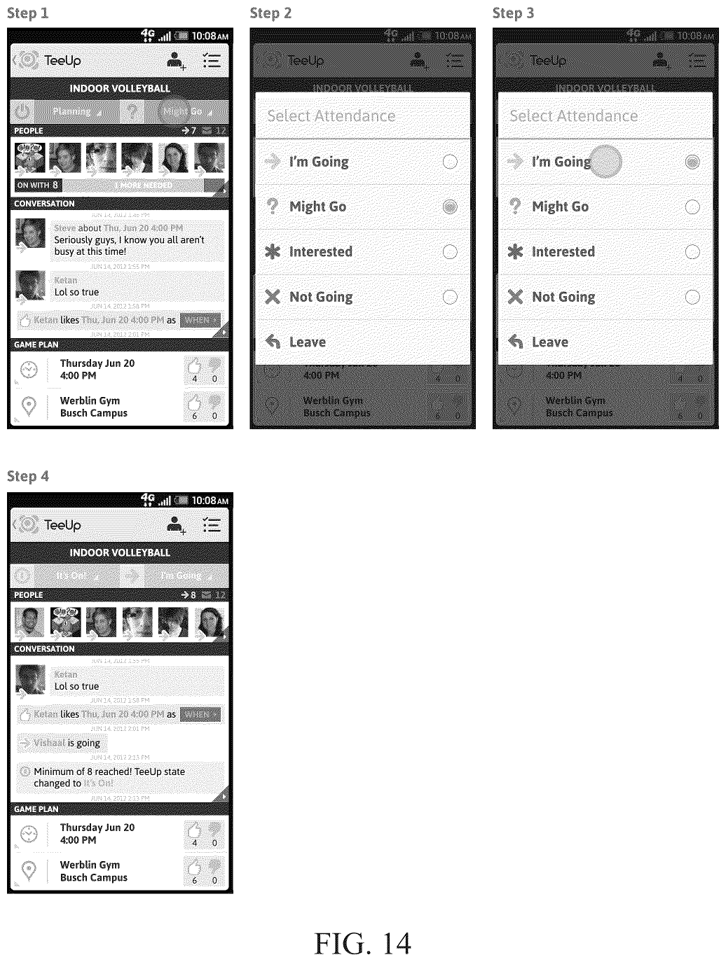

FIG. 14, Scenario 1—Getting enough participants for 6 v 6 pickup indoor volleyball. The scenario begins with FIG. 14—Step 1. It shows Vishaal's view of a TeeUp he was invited to titled “Indoor Volleyball”. This image shows the current coordination state is set to “Planning”, that Vishaal has shared with the group previously that he “Might go”, that if 12 people saying that are “Going” the global state will change from “Planning” to “It's On”. The time of the activity is give as 4 pm at Werblin gym, although both of these are also open to change as they have not been set by the organizer into the decided mode. Visual decides to say that he is going, so he presses his user-state (“Might Go”) which brings up FIG. 14—Step 2 showing his current state is “might go” but that it can change at ease to various other states. In FIG. 14—Step 3 Vishaal changes his state to “Going”. FIG. 14—Step 4 shows the TeeUp UI that results from Vishaal's actions in Step 3. Vishaal's action of stating he is “going is posted to the conversation, and shown in the conversation panel of the TeeUp, further as Vishaal is the 12.sup.th individual to state that he is going, his actions have resulted in the critical mass of users being reached, the removal of the “On If” bar on the people panel, the change of the group coordination state from “planning” to “It's On” and an associated message being posted to the conversation “Minimum of 12 reached! TeeUp state changed to It's On!”.

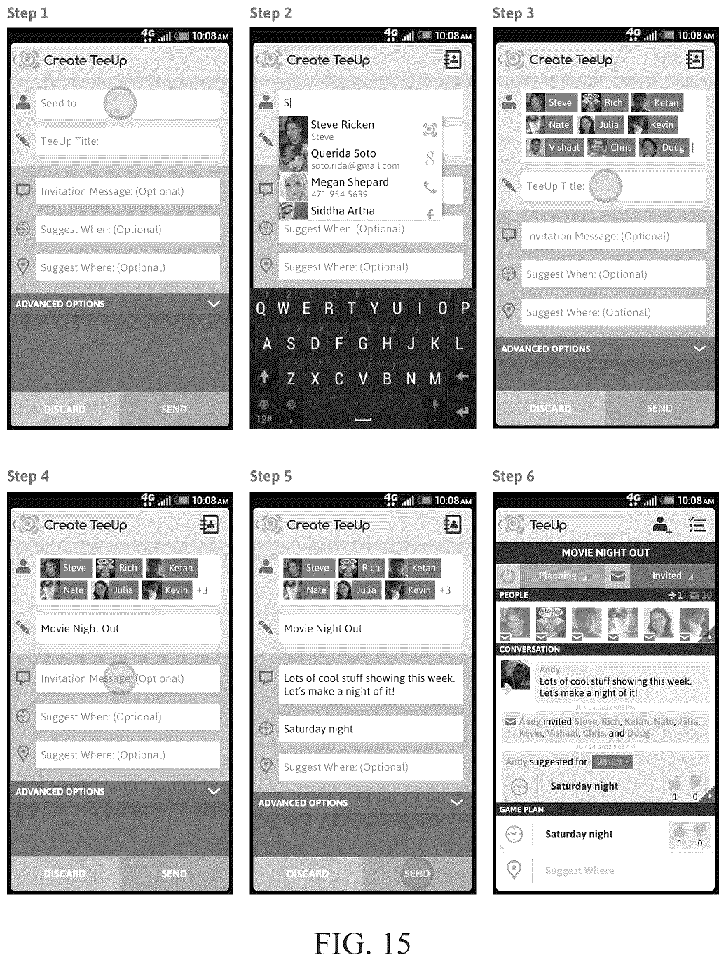

FIG. 15 Scenario 2—Andy creates a TeeUp for a movie night out. FIG. 15, Step 1 shows the create TeeUp UI with the details of some of the contacts to be invited entered and other fields left blank, and the send button is not enabled. FIG. 15, Step 2 shows the create TeeUp UI with Andy having listed invitees and a TeeUp title, with these two fields now containing information the send button becomes enabled. Creating a TeeUp can therefore be as simple as sending a text message. FIG. 15, Step 3 shows the Create TeeUp screen once Andy has also provided an invitation message, and suggested that they carry out the activity on Saturday night. It should be noted that the suggestion for “when” is not an exact calendar entry but rather conversational English. FIG. 15 Step 4 shows the TeeUp UI that results from Andy creating the TeeUp by hitting the send button in Step 3.

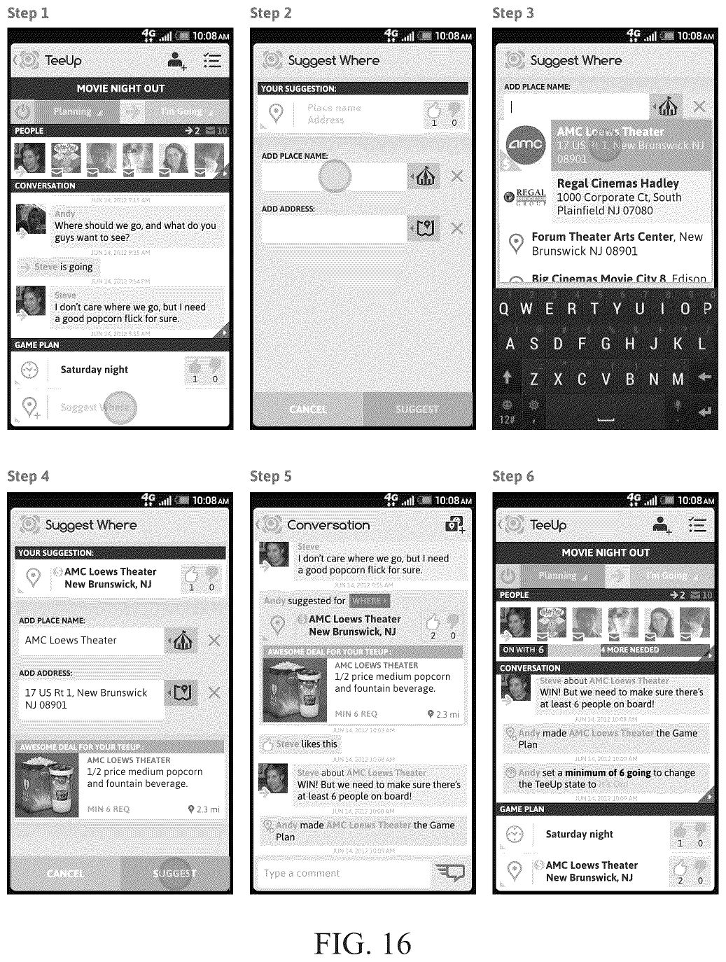

Scenario 3 shown in FIG. 16 is a continuation of the scenario 2 a TeeUp for coordinating a movie night out. FIG. 16, Scenario 3—Andy suggests that the group go to AMC new Brunswick because it has a good deal on popcorn and drinks. FIG. 16, Step 1 shows the TeeUp UI from Andy's perspective shortly after he created it. Steve has stated that he doesn't care what they see or where they go so long as the Popcorn is good. As a result, Andy presses on the “suggest where” area of the game plan. FIG. 16, Step 2 shows the “new suggestion” UI, and Andy selects the “Add Place Name” area which results in FIG. 16 Step 3. In Step 3 Andy starts to type a place name and as a result a smart list is displayed which includes a deal associated with going to AMC Lowes. In FIG. 16 Step 4 Andy examines the detail of the deal, which gives half price for medium popcorn and fountain beverages for a group of 6 or more. Andy likes this deal and so he suggests it to the group. How Andy's action impacts on the coordination conversation is shown in FIG. 16, Step 5, where the conversation UI is shown. In Step 5 the deal is embedded in the conversation as a suggestion made by Andy, which Steve has decided to also Like. In this way Coo-e coordinator has supported a product recommendation becoming part of the group conversation. In addition Steve notes that because 6 people are required and this is his preferred option that the Suggestion should be moved to the game plan. The conversation history shows that Andy takes this next step and makes AMC Loews the game plan. This in turn results as shown in Step 6 that the “on with” bar is displayed, with the minimum number for the deal to occur set as the “on with” number. This occurs because Andy has moved a deal requiring a minimum of 6 onto the game plan. In this way advertising, recommending, suggesting, conversation, game plan actions, and the overall coordination state are all seamlessly linked together.

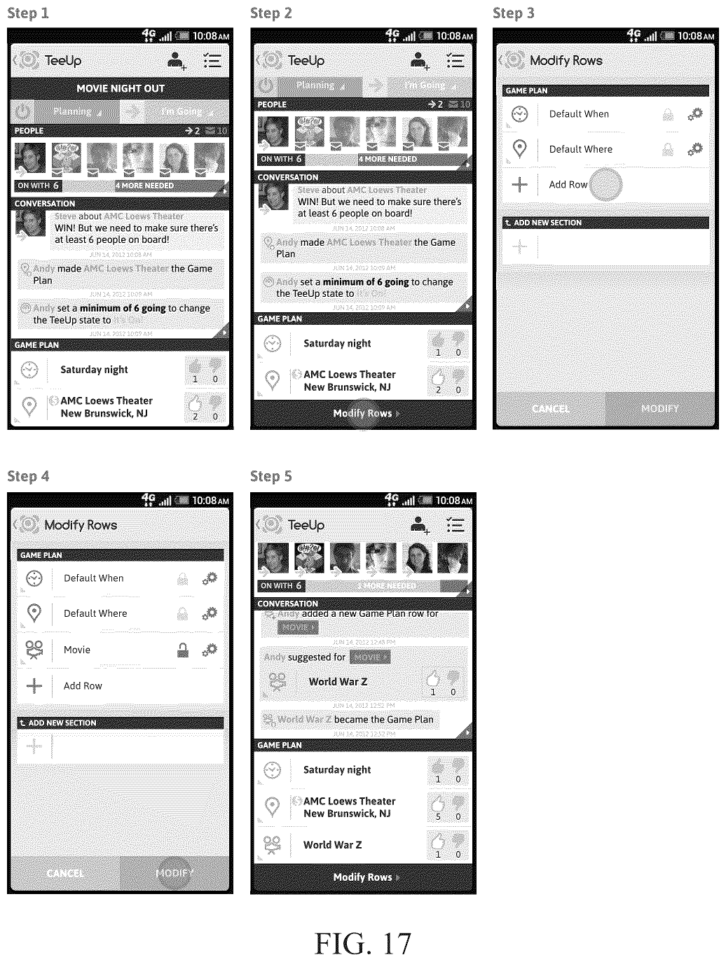

Scenario 4 as shown in FIG. 17 is a continuation of the scenario 2 through 3 a TeeUp for coordinating a movie night out. Andy in this scenario adds a Game Plan row or activity-detail type that allows the group to choose between Movies. FIG. 17, Step 1 shows that the TeeUp UI that Andy is acting on. In Step 2 he scrolls down the TeeUp UI and selects the modify row button. Step 3 shows the modify rows screen, and Andy selecting Add Row. Step 4 displays how Andy modifies the Game Plan rows. Step 5 shows the TeeUp UI once the Game Plan has been modified, with Andy having suggested to the group World War Z, which he also places on the Game Plan. Two alternative processes exist to adding the Game Plan row, that are not outlined in this scenario. The first is via the make new suggestion quick action button in the conversation UI (this can be supported as general option or generated through context aware processing of TeeUp data). Alternatively, the context-aware recommendation system can prompt Andy once the user-context is identified (e.g. a movie night out) if he wanted a movie suggestion row added to the Game Plan. Similarly, a discussion about venues for dinning can result in cuisine type Game Plan rows being recommended for addition. It is important to note the design aims to support natural conversation, not a particular order of user actions and as such no such order is enforced or imposed on users.

Scenario 5 is a continuation of the scenario 2 through 4 a TeeUp for coordinating a movie night out. FIG. 18, Scenario 5 begins with Andy reviewing the coordination conversation and clicking on the suggestion by Rich that they meet “Saturday, June 22 7:00 PM”. Step 2 shows the outcome of his action taken in Step 1, which brings him to the suggestion details screen, in which he can view all the comments made about that particular suggestion. He then presses on “When” which results in Step 3, the suggestion list/activity-detail summary page for the row “When”. Andy is able to see from this screen that “Saturday Night” is the current “when” suggestion on the Game Plan. As there is consensus building around the details “Saturday, June 22 7:00 pm” Andy clicks on the suggestion quick action control which is shown in Step 4. Andy then in Step 4 selects Make Game Plan. This results, as shown in Step 5 and 6 in “Saturday, June 22 7:00 pm” moving to the Game Plan.

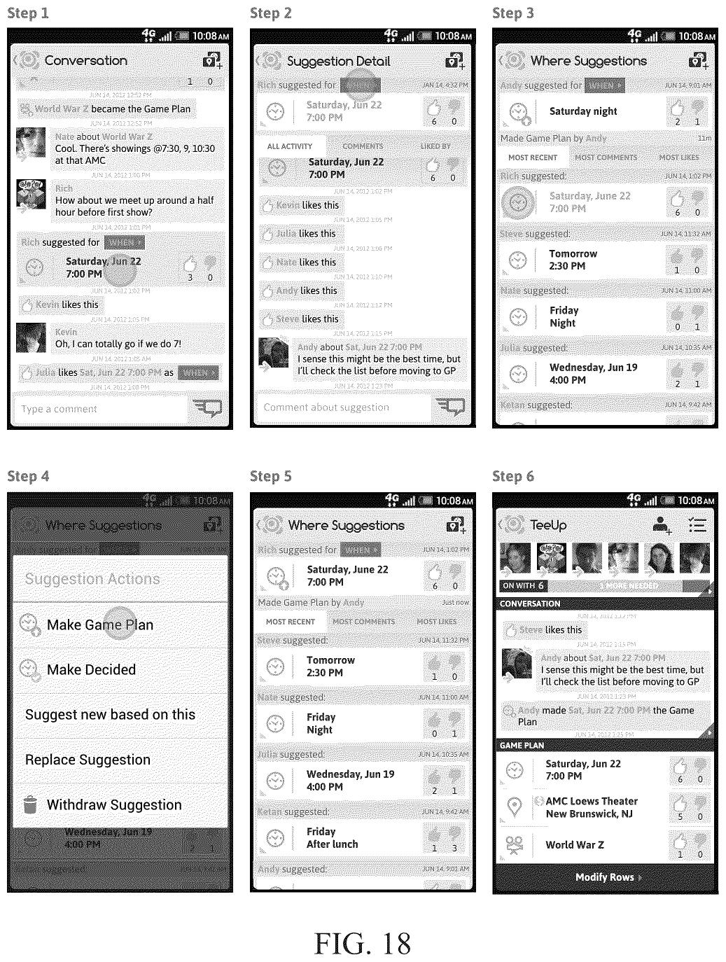

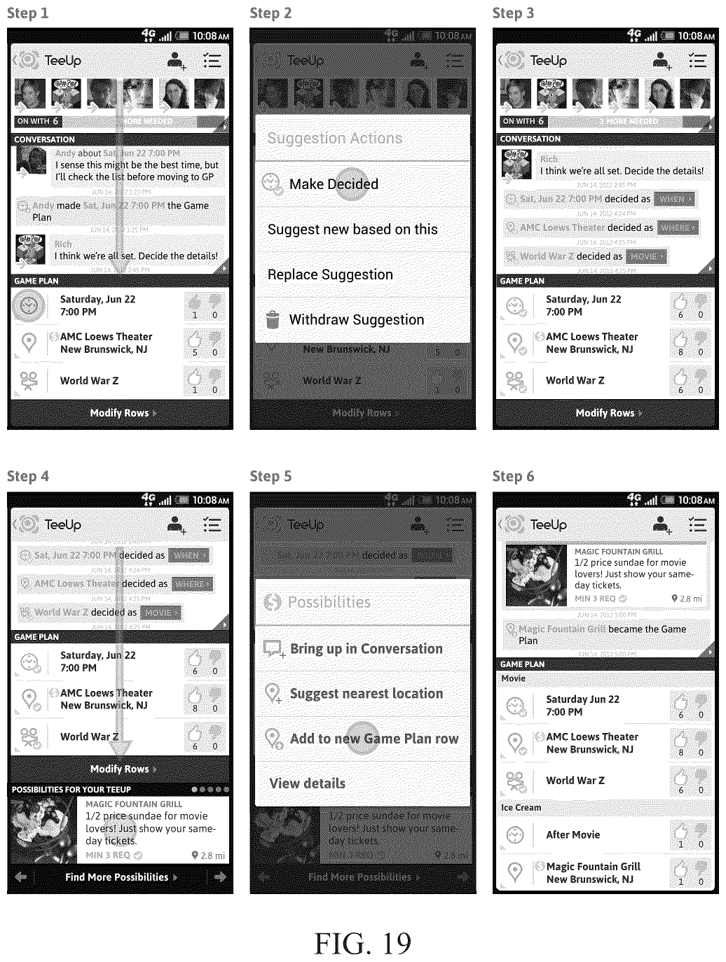

Scenario 6 (FIG. 19) is a continuation of the scenario 2 through 5 a TeeUp for coordinating a movie night out. In FIG. 19, Step 1 Andy after scrolling slight down the TeeUp decides to select the suggestion quick action control, and in Step 2 makes the time decided. In Step 3, we see the result of his making all Game Plan rows decided. In Step 4, Andy scrolls further down the TeeUp screen and examines the recommendations made below the Game Plan. Andy notices that there is a deal for ice cream after the movie, and in Step 5 puts it on the Game Plan. The ice cream offer is used to illustrate that once the core activity details have been decided supplemental activities can be recommended using coordinator's context aware recommendation system. In this case the core activity is a movie night has been decided and so the system is able to recommend supplemental activities. In this case the supplemental activity recommended is ½ priced sundaes for a group of 3 or more with movie tickets. Steps 4-6 shows that like the movie watching deal Andy is able to suggest the recommendation to the group and if desired move it to the Game Plan. As it is a supplemental activity by default when the suggestion is added to the Game Plan a new section is automatically created and added to contain it. This is shown in Step 6 where the new expanded Game Plan of the TeeUp UI is shown. It should be noted that the recommendation is again embedded in the group conversation as a suggestion of Andy's as shown in Step 6.

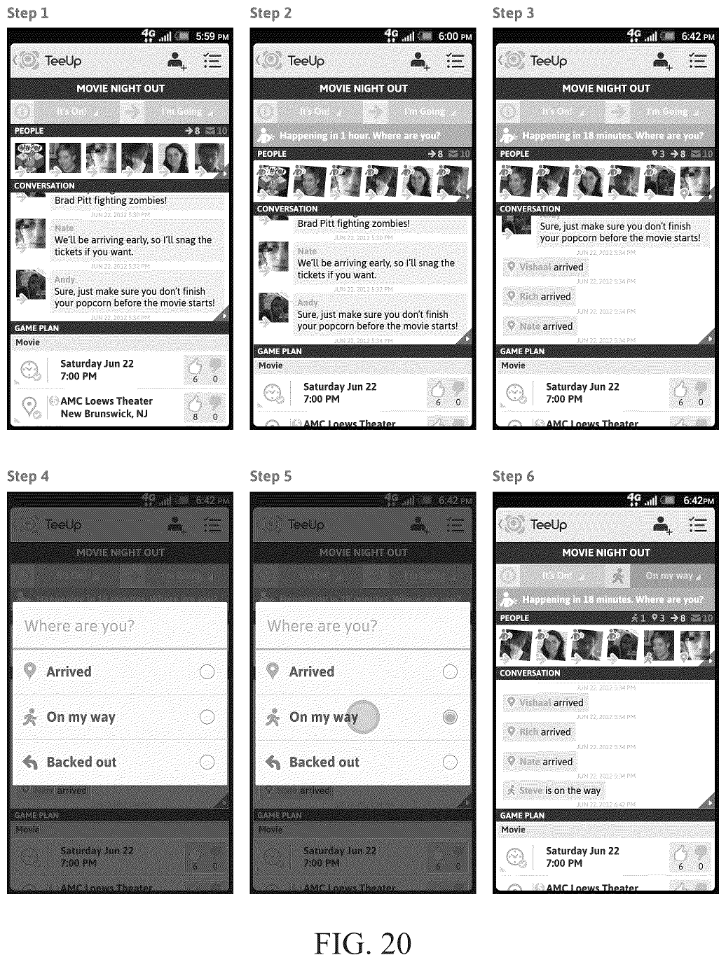

Scenario 7 is a continuation of the scenario 2 through 6 a TeeUp for coordinating a movie night out. FIG. 20, Scenario 7—Shows Steve receives system nudges that prompt him to share attendance status for the benefit of the coordinating group. Step 1 of Scenario 7 occurs on 5.48 pm, Saturday June 22 it shows the TeeUp with everything decided, the group coordination state being “it's on!”, and Steve having shared that he is “going”. Step 2 of Scenario 7 it is now 6 pm and because the activity is happening in 1 hour Steve gets a system nudge to encourage him to share is attendance status/plans with the coordinating group. As Steve is engaged in another activity, he does not look at his phone and ignores this nudge and associated system notifications. In Step 3 it is 6.42 pm and the nudge on the phone highlights that the activity is happening in 18 minutes. Steve has just taken out his phone and looks at the TeeUp and at this point and decides to act and share is attendance state. He clicks on the user nudge/user attendance state area and sets his status to “On My Way”. This results in Step 6 where Steve's new status is shared with the group via the conversation window and people area of the TeeUp and various People UIs.

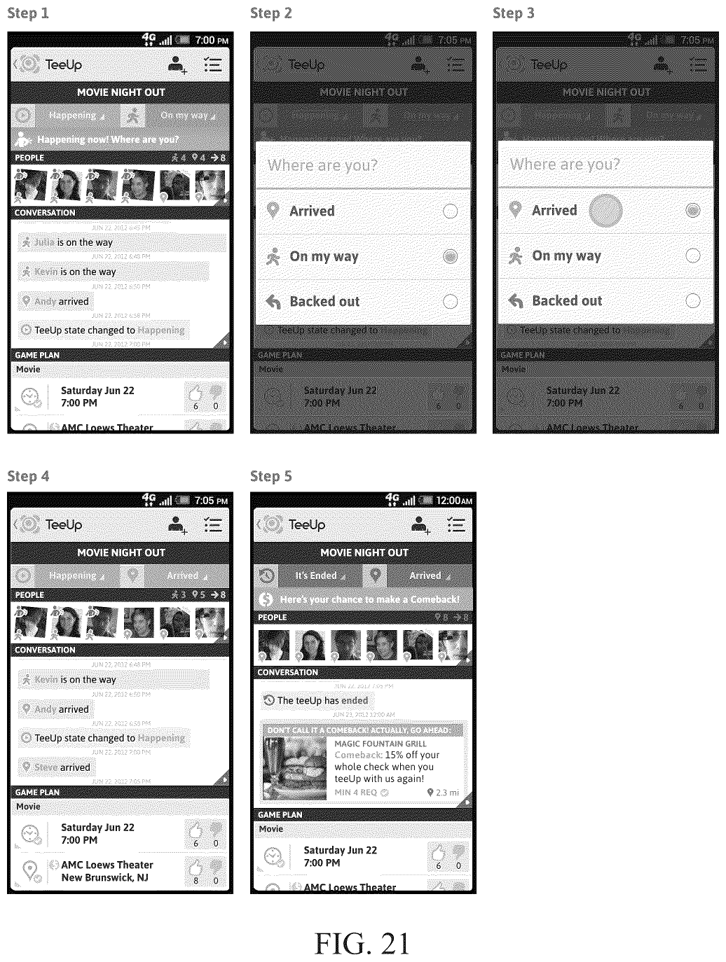

Scenario 8 is a continuation of the scenario 2 through 7 a TeeUp for coordinating a movie night out. FIG. 21, Scenario 8—Steve receives a nudge that and event is happening now which prompts him to share that he has arrived and then receives an offer for repeat business to a local food venue. In Step 1 FIG. 21, Steve has arrived at the parking lot of the cinema at 7 pm at which point he receives an additional system nudge that the activity is “happening now!”. As a result, he clicks on the user-status/nudge area of the TeeUp UI. In Step 2 and 3 Steve changes his status from “On My Way” to “Arrived”. The next day after the activity is over Steve and other participants receives an offer associated with making a come back (Step 5). Again the recommendations are contextually appropriate and do not interfere with the overall user experience while building customer loyalty. Such contextualization of recommendations is extremely difficult for computer recommendation systems to make without the data from a richly scaffolded coordination conversation.

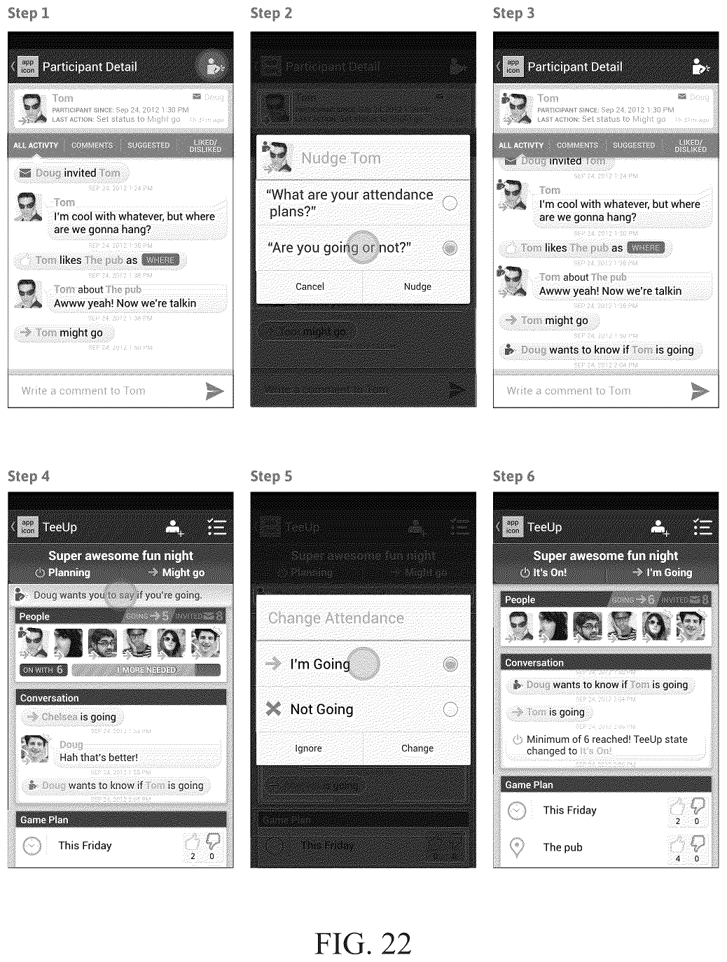

Scenario 9 (FIG. 22) illustrates the user-generated Nudges of other users. It is presented showing an different instantiation of Coo-e Coordinator which while stylistically different clearly illustrates the invention. In FIG. 22 Step 1 Doug is viewing the Participant Detail screen of the TeeUp Participant Tom. From the participant detail screen Doug then selects the Nudge Quick button. The nudge quick action button is also displayed in FIGS. 1C and E, FIG. 6 and FIG. 8 B. As this is a single user nudging another single user who is not an organizer. The nudge options provided focus on the user changing his/her attendance state as displayed in Step 2. In Step 3 Doug can be see that Tom is now Nudged, as indicated on his avatar and of course as reflected in the TeeUp Data and State Model. Step 4, 5 and 6 of FIG. 22 displays Tom interacting with the same TeeUp. In Step 4 Tom's TeeUp has a Nudge message from Doug asking him to state if he is going. Tom then acts on the Nudge in Step 4 bringing up the Change Attendance Menu in Step 5 where he states that he is going. Step 6 shows how Tom's TeeUp UI looks as a result of his responding to the Nudge, with the Nudge notification no longer on the screen.

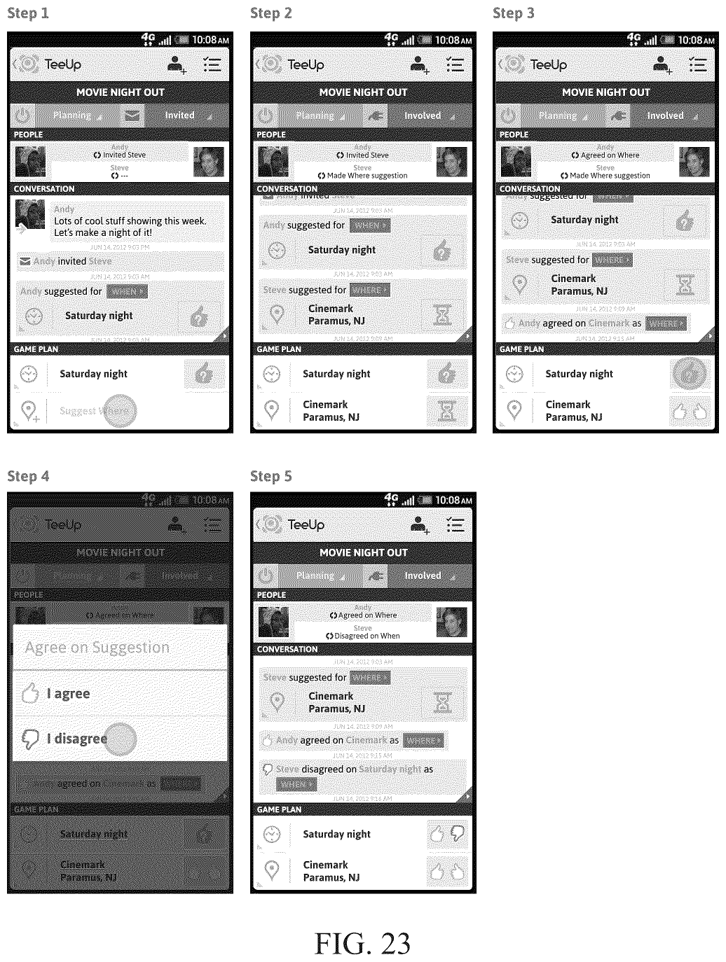

Scenario 10 (FIG. 23) shows how the coordination scaffolds differ for paired interactions. Step 1 show the TeeUp UI from Steve's perspective. It shows that Andy has suggested that they meet Saturday Night and Steve has as yet not responded with a like or dislike to Andy's suggestion, represented by the thumbs up with a question mark. Steve decides to suggest a location for the activity (Step 1) by selecting the Where Row of the Game Plan. Step 2 shows how the where like/dislike appears to Steve as a result of his making a suggestion directed at Andy that he has not yet responded to (represented by a clock symbol to indicate that he is waiting for a response). In Step 3 we see that Andy has agreed on the where row suggestion and it now has two thumbs up. Steve decides to respond to Andy's suggestion for Saturday night by clicking on the (thumbs up+question mark) like/dislike quick action of the suggestion. Unfortunately, Saturday night is not going to work so he selects that in Step 4 and in Step 5 the results of this action are displayed as a suggestion with one thumb up and one thumb down. Hence Coo-e Coordinator scaffolds both paired and group interactions through the suggestion management system.

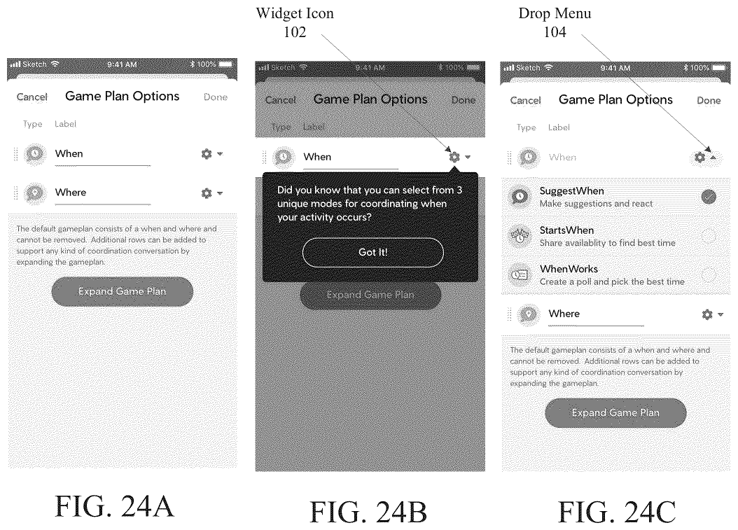

FIGS. 24A-24C illustrate a plurality of “When” modes provided by the TeeUp UI. The modes include a “SuggestWhen” mode, a “StartsWhen” mode, and a “WhenWorks” mode, each of which will be discussed in further detail below. FIG. 24A shows the TeeUp UI (hereafter “interface”) when displaying Game Plan Options comprising a “When” row and a “Where” row. FIG. 24B shows the interface when a user selects the widget icon 102. The widget icon 102 allows the user to select from three unique modes for coordinating when an activity occurs. FIG. 24C shows the interface when the user selects a when-row drop menu 104. Specifically, the when-row drop menu 104 allow the user to select the SuggestWhen mode, the StartsWhen mode, and the WhenWorks mode. The SuggestWhen mode allows the user to make suggestion about when to hold an event and react to the suggestions of other users. The StartsWhen mode allows the user to share his or her availability and find the best time to start an event based on the availability of other users. The WhenWorks mode allows the user to create a poll and pick a best time to start an event based on the results of the poll.

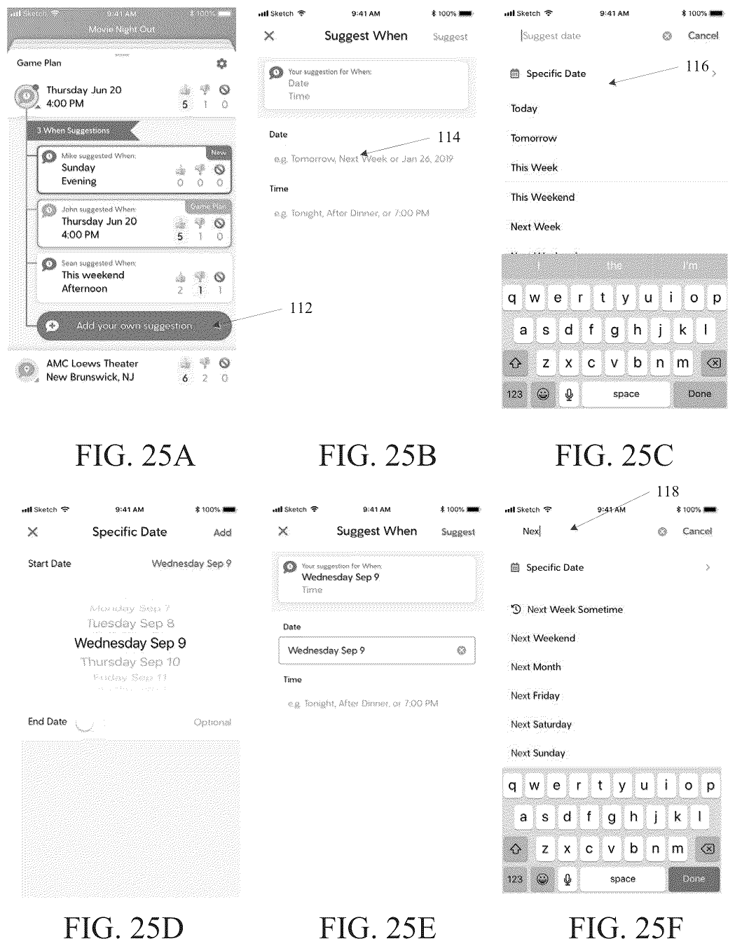

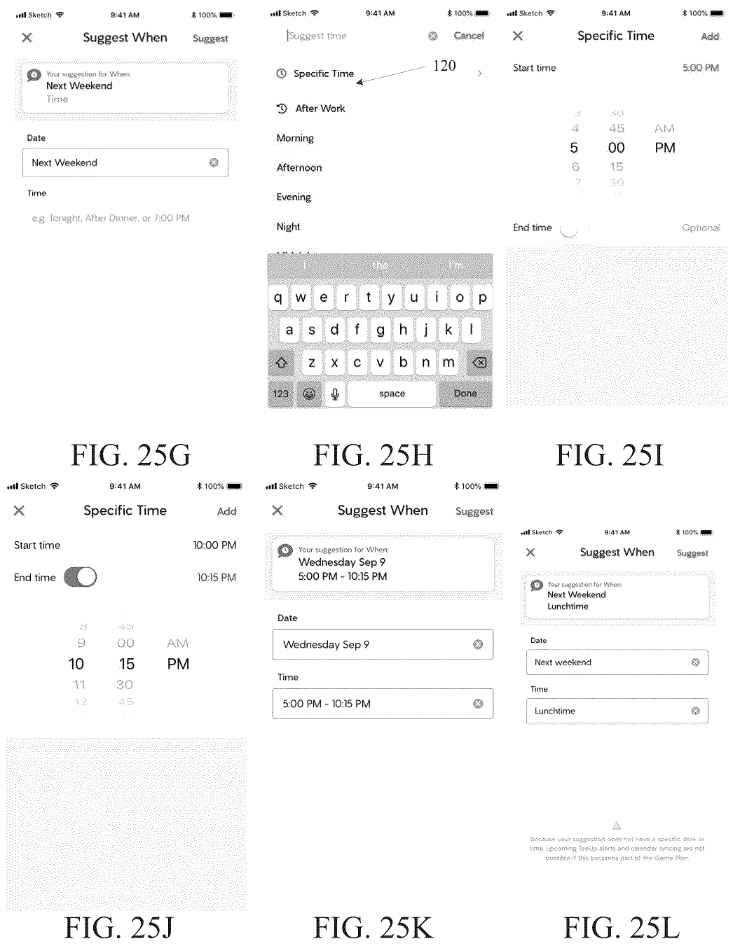

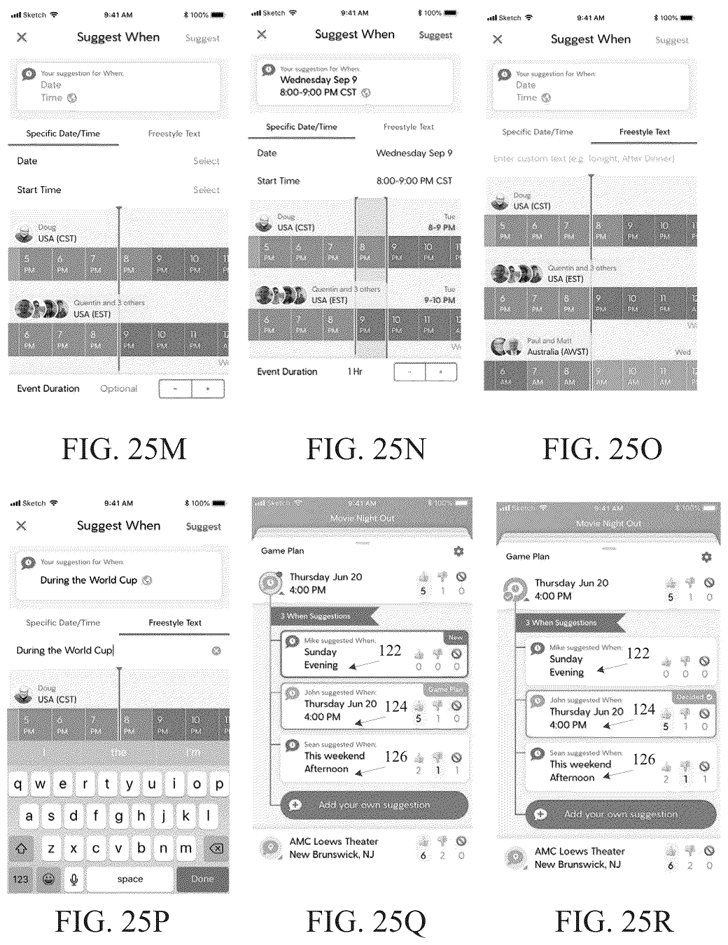

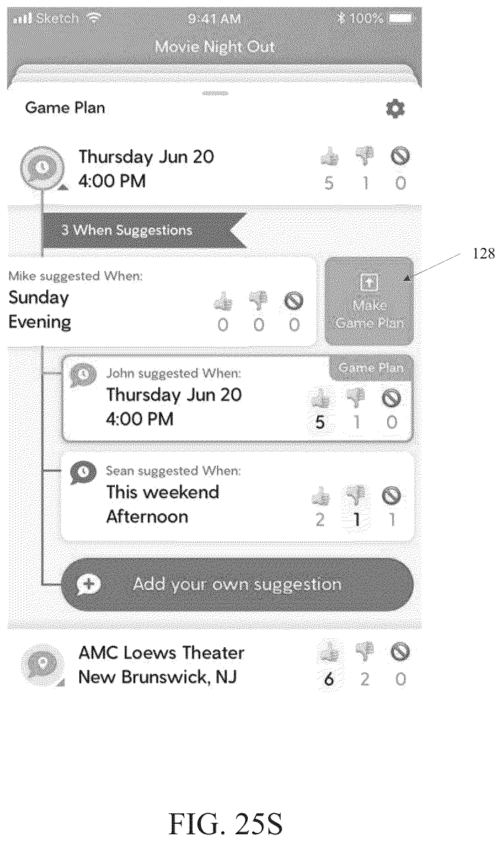

FIGS. 25A-25S show two illustrative scenarios involving operation by the user of the SuggestWhen mode of the interface. The first scenario includes using the SuggestWhen mode when a group includes people from the same time zone. The second scenario includes using the SuggestWhen mode when a group includes people from multiple time zones. Both scenarios will be discussed in detail below.

In a first example, the SuggestWhen mode can be selected from the when-row drop menu 104. In another example, the SuggestWhen mode can be selected by adding a suggestion to an existing game plan. For example, FIG. 25A shows a “Movie Night Out” TeeUp with the “Game Plan” tab displayed. The user can select the “Add your own suggestion” button 112 to open the SuggestWhen mode interface. FIG. 25B shows the SuggestWhen mode interface when a group includes people from the same time zone. Selecting the “Date” button 114 will bring up the Suggest Date interface seen in FIG. 25C. The user can select a specific date by selecting the “Specific Date” button 116, or the user can select an option from the drop down menu of suggested dates (e.g., Today, Tomorrow, This Week, This Weekend, Next Week, etc.). Selecting the “Specific Date” button 116 will bring the user to the interface seen in FIG. 25D, where the user can use a scroll wheel to select a specific date, which will bring up the interface seen in FIG. 25E (where the date is set to Wednesday, September 9th). Alternatively, the user can type a desired date in the “Suggest Date” prompt 118, as seen in FIG. 25F. The “Suggest Date” prompt 118 includes an autocomplete function which shows options in the drop down menu (e.g., Next Week Sometime, Next Weekend, Next Month, Next Friday, Next Saturday, Next Sunday, etc.). Selecting an option from the drop down menu of suggested dates (e.g., Next Weekend) will bring up the interface seen in FIG. 25G.

Next, the user can select a time by selecting the “Time” button. The user can select a specific time by selecting the “Specific Time” button 120, or the user can select an option from the drop down menu of suggested times (e.g., After Work, Morning, Afternoon, Evening, Night etc.), as seen in FIG. 25H. FIGS. 25I and 25J show the interface for selecting a start time and an end time. FIGS. 25K and 25L show examples of the interface when the date and time are selected.

FIGS. 25M-25P show the SuggestWhen mode interface when a group includes people from different time zones. The user can select a specific date and time for an event or enter freestyle text for the date and time (e.g., “During the World Cup”). When selecting the date and the time, the user will be shown the time zones of each participant in the group. For example, as seen in FIG. 25O, selecting a start time of 8:00 PM CST (Central Standard Time) will show each participant's time zone, where Doug's time zone is CST, Quentin's and 3 others' time zone is EST (Eastern Standard Time), and Paul's and Matt's time zone is AWST (Australian Western Standard Time). Importantly, this feature allows multiple users in multiple different time zones to easily coordinate activities. Indeed, the time zone graphs shown in FIGS. 25M-25O provide a significant technological improvement over existing computer-based scheduling applications (such as the calendar feature in Microsoft Outlook) in that various user's time zone information is displayed in a single graphical interface, and events can be optimally and rapidly planned (and transmitted to other users) such that the user can pick a time for an event during which all users (in their respective time zones) are likely to be able to attend an event. This greatly saves the user time in planning events, and speeds up and simplifies coordination communications amongst various users using mobile devices.

FIGS. 25Q and 25R show interfaces with three “when” suggestions 122, 124, 126, one from Mike, one from John, and one from Sean. A like/dislike voting system (as seen by the “thumbs up icon, thumbs down icon, and prohibition sign icon) can be used to select a time for the “Movie Night Out” Game Plan. The user can select a GamePlan by sliding a choice (e.g., one of the suggested Gameplans) and selecting the “Make Game Plan” button 128, as shown in FIG. 25S.

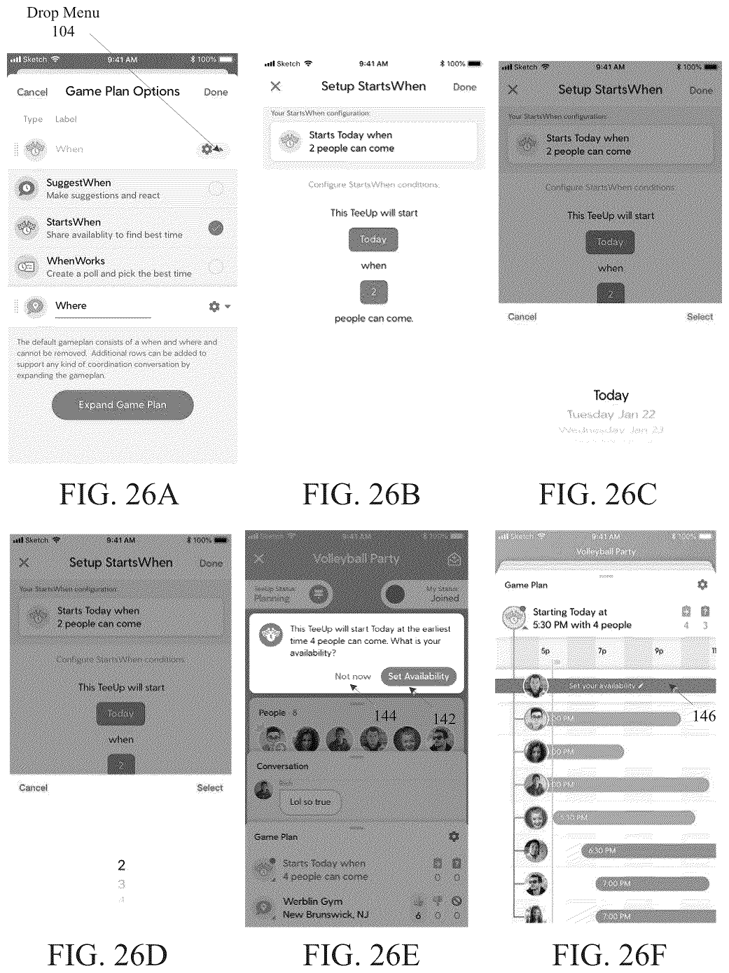

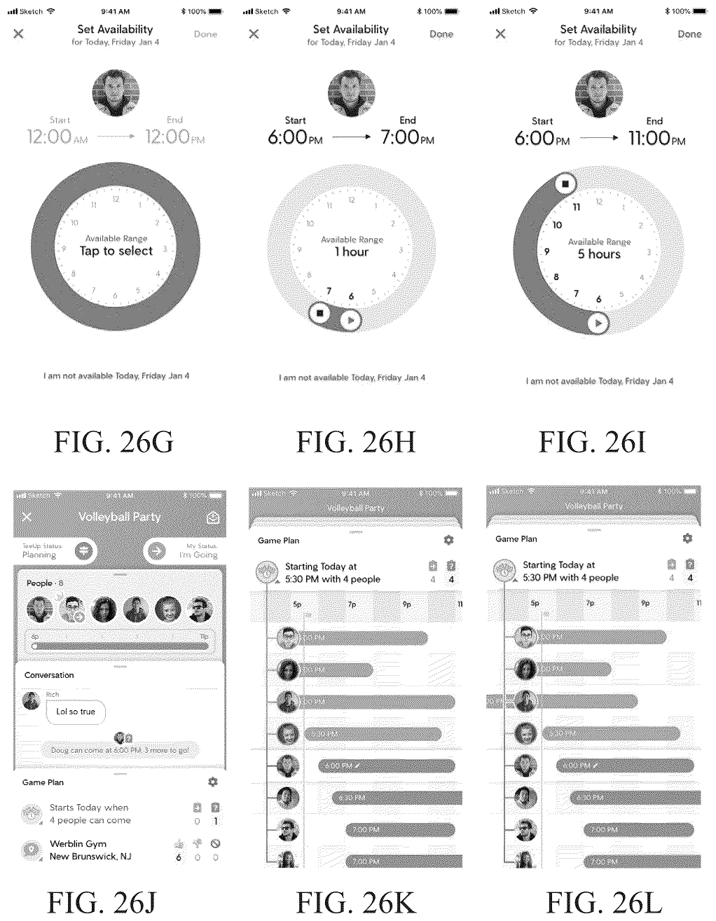

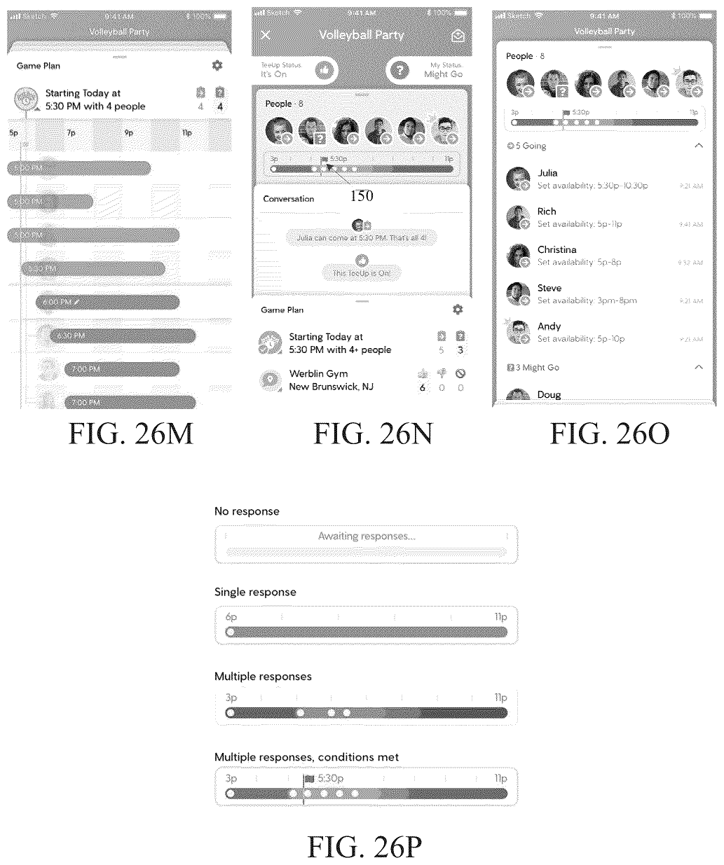

FIGS. 26A-26P show the StartsWhen mode of the interface. FIG. 26A shows the when-row drop menu 104 with the StartsWhen mode selected. FIG. 26B shows the StartsWhen setup interface. The user can configure an event date, as shown in FIG. 26C by the date scroll wheel, and a condition to start the event, as shown in FIG. 26D by the number of participants scroll wheel. For example, the condition comprises a minimum amount of people electing to attend the event. FIG. 26E shows the interface with the event being a “Volleyball Party,” the event date being “Today,” the condition to start the event (e.g., minimum amount of people electing to attend) being 4, and a prompt asking whether to set the user's availability. The user can set their availability by selecting the “Set Availability” button 142, or select the “Not now” button 144 to set their availability at a later time. FIG. 26F shows a Game Plan tab for the “Volleyball Party” with eight people, the user being the first person. Each person's availability is shown by a horizontal bar displaying each user's earliest available time. As seen, the user (first person) has yet to set their availability. By selecting “Set your availability” bar 146 seen in FIG. 26F, or the “Set Availability” button 142 seen in FIG. 26E, the user is prompted with a “Set Availability” interface shown in FIG. 26G. The user can tap and slide the available range icon to set a “Start” and “End” availability time, as shown in FIGS. 26H and 26I. FIG. 26J shows the interface with the “People” tab selected. As seen, the user's availability is set from 6 PM to 11 PM. FIGS. 26K, 26L, and 26M show the “Game Plan” tab with 8 people and each person's available time. FIG. 26N shows the “People” tab where each response is noted on a timeline. Each dot represents the start time of a person's availability. The flag 150, set at 5:30 PM, represents the start time of the event (e.g., the volleyball party). The start time is set to 5:30 PM because 5:30 PM is the earliest time that at least 4 people can attend. FIG. 26O shows the timeline with each person's availability below the timeline. FIG. 26P shows different examples of the timeline. Specifically, FIG. 26P shows a timeline with no responses, with a single response, with multiple responses, and with multiple responses and the conditions being met.

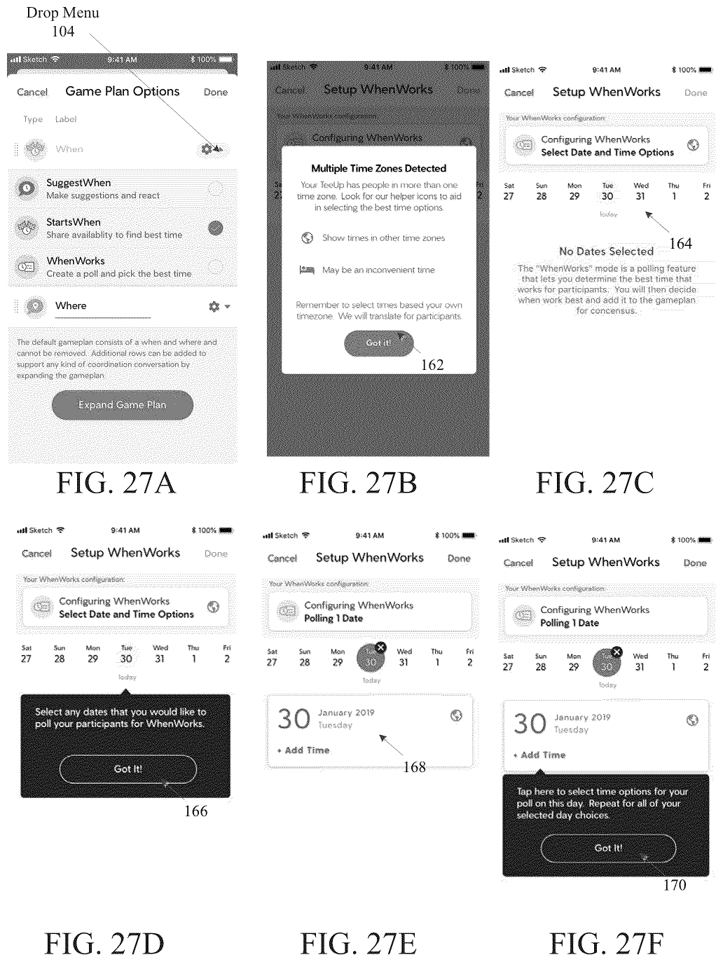

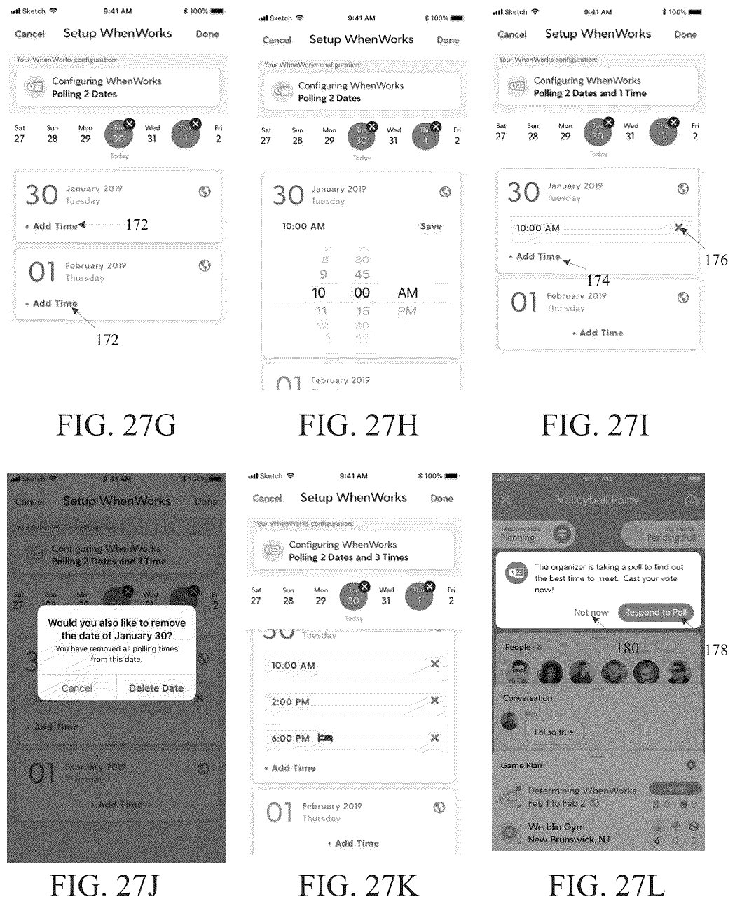

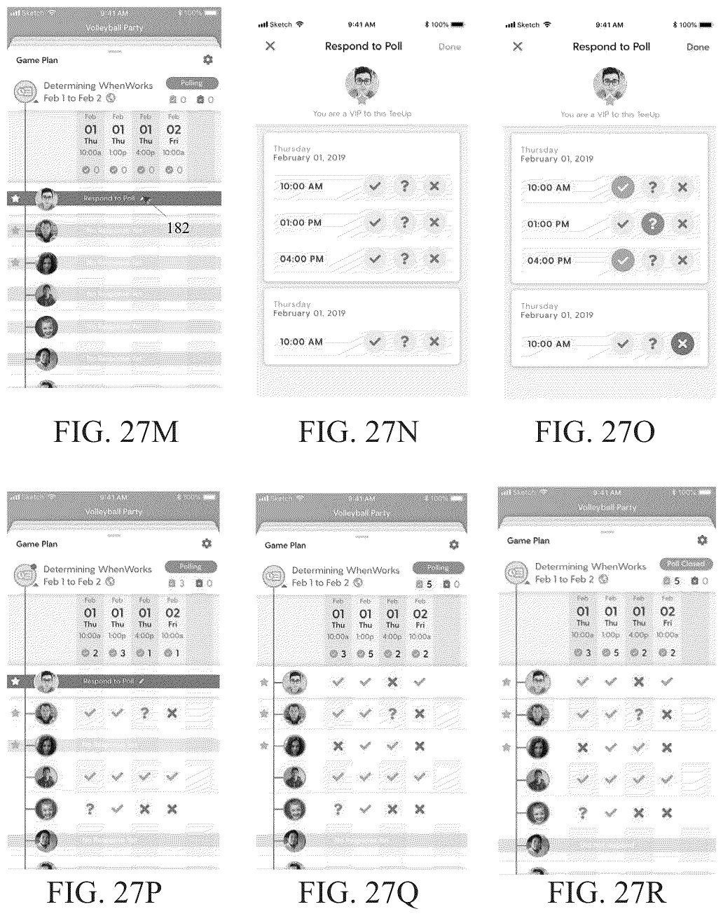

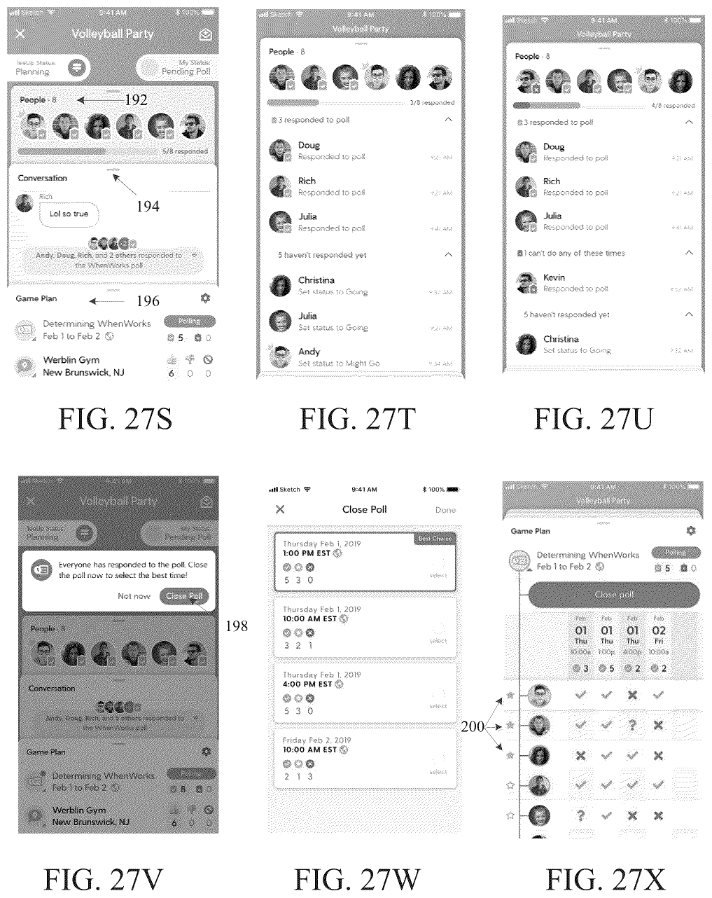

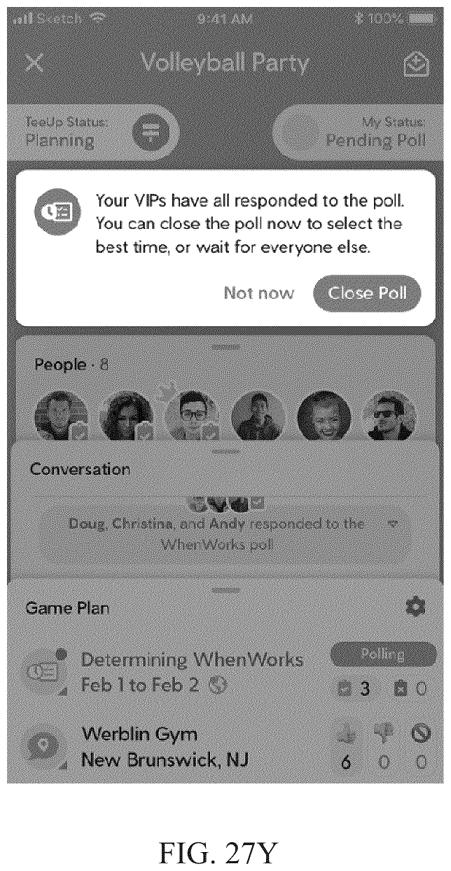

FIGS. 27A-27Y show the WhenWorks mode of the interface. FIG. 27A shows the when row drop menu 104 from where the WhenWorks mode can be selected. FIG. 27B shows a notification instructing the user that multiple time zones among participants in the group are detected. The user can select the “Got it!” button 162 to remove the notification. FIG. 27C shows an interface of the WhenWorks setup menu, which shows a horizontal scroll wheel 164 used for selecting a date. It is noted that multiple dates can be added by the user. FIG. 27D shows the interface of the WhenWorks setup menu with a notification, stating “Select any dates that you would like to poll your participants for WhenWorks.” Selecting the “Got it!” button 166 will close the notification. FIG. 27E shows the interface of the WhenWorks setup menu with a selected date 168 (Jan. 30, 2019). As indicated by the notification shown in FIG. 27F, a time or time range can be added to each selected date, where selecting the “Got it!” button 170 will close the notification. FIG. 27G shows the interface of the WhenWorks setup menu with two selected dates (Jan. 30, 2019 and Feb. 1, 2019). Selecting the “Add Time” button 172 on a selected date will open a time scroll wheel for that date, as shown in FIG. 27H. Specifically, FIG. 27H shows the interface of the WhenWorks setup menu with a time scroll wheel on the selected date of Jan. 30, 2019. FIG. 27I shows a selected time of 10:00 AM for the selected date of Jan. 30, 2019. A user can select multiple times and time ranges for each date by selecting the “Add Time” button 174 after a previous time is selected. Selecting the “x” button 176 on a date or a time will prompt the user with confirmation notification inquiring whether the user would like to remove said date, time, or both. For example, FIG. 27J shows a confirmation notification from the user electing to remove the 10:00 AM time on January 30, where the confirmation notification inquires whether the user would like to also remove the date of January 30 because all the polling time(s) (e.g., 10:00 AM) for that date have been removed.

FIG. 27K shows the interface with three time selected for the date January 30. The times include 10:00 AM, 2:00 PM, 6:00 PM. FIG. 27L shows a notification message informing a member of the group that the organizer is taking a poll to find out the best time to meet, and instructing the member to cast a vote(s) in the poll. The member can elect to cast their vote(s) by selecting the “Respond to Poll” button 178, or elect to respond at a later time by selecting the “Not now” button 180. It is noted that each member in the group will receive this notification. FIG. 27M shows a status of the polling. Specifically, FIG. 27M shows four polling options (February 1 at 10:00 AM, February 1 at 1:00 PM, February 1 at 4:00 PM, February 2 at 10:00 AM) where no user has yet to response. For each user, a pencil button 182 will appear next to their photo, which can be used to open a polling interface, as seen in FIG. 27N. The user will be presented with three options for each date in the poll, a yes button (a check mark), a maybe button (a question mark), and a no button (an x mark). As seen in FIG. 27O, the user can select one mark for each date. FIGS. 27P-27R show different examples of responses by the user to the poll, where an aggregate of yes votes for each date are displayed under said date.

FIG. 27S shows an interface with three tabs, a “People” tab 192, a “Conversation” tab 194, and a “Game Plan” tab 196. The “People” tab 192 shows that 5 out of 8 people responded to the poll. FIGS. 27T and 27U show an expanded view of the “People” tab 192, where whether each person responded is shown. FIG. 27V shows a notification message indicating that everyone has responded to the poll, and prompting the user whether to close the poll or not. Selecting the “Close Poll” button 198 will display a “Close Poll” interface, as seen in FIG. 27W. The user can then select any of the poll options, where the option with the most “yes” votes will be marked as “Best Choice.”

FIG. 27X shows an interface with a row for each member, a column for each poll date, and how each member voted for each poll date. Further, a star icon 200 is enabled for the top three members. The star icon indicates whether the member is a “VIP” member or a “non-VIP” member. FIG. 27Y shows an interface with a prompt instructing the user that each “VIP” member of the group has responded to the poll, and the user can either close the poll, or wait for the remaining “non-VIP” members to respond to the poll. The user can designated which member of a group are to be designated as VIP members.

Having thus described the system and method in detail, it is to be understood that the foregoing description is not intended to limit the spirit or scope thereof. It will be understood that the embodiments of the present disclosure described herein are merely exemplary and that a person skilled in the art may make any variations and modification without departing from the spirit and scope of the disclosure. All such variations and modifications, including those discussed above, are intended to be included within the scope of the disclosure. What is intended to be protected by Letters Patent is set forth in the following claims.

What is claimed is:

1. A method for enhanced data collection and management for coordinating communications relating to social group activities, comprising the steps of:
generating and displaying on a computing device a unified scaffolded graphical user interface to a plurality of users involved in communications relating to social group activity planning, the unified scaffolded graphical user interface generating real-time group coordination state information for the plurality of users using a state model and a data model;
generating and displaying a first panel within the unified scaffolded graphical user interface, the first panel displaying information relating to a stage of group coordination and a description of the social group activity;
generating and displaying a second panel within the unified scaffolded graphical user interface, the second panel displaying an attendance state for each of the plurality of users;
generating and displaying a third panel within the unified scaffolded graphical user interface, the third panel allowing each of the plurality of users to engage in real-time messaging between each other and to display coordination actions;
generating and displaying a fourth panel within the scaffolded graphical user interface, the fourth panel allowing each of the plurality of users to view a current plan or a suggestion for the social group activity relating to at least one of a time or a location;
receiving, by the scaffolded user interface, a first input for allowing a user of the plurality of users to select one of a plurality of modes for determining a proposed start time of the social group activity;
receiving, by the scaffolded user interface, a second input for allowing the plurality of users to set one of the plurality of proposed start times as a selected time for the social group activity;
receiving, by the scaffolded user interface, a third input for allowing each user of the plurality of users to vote on each of the one or more proposed times; and
processing the attendance state, the real-time messaging, the proposed start time, the selected time, and vote information to generate a coordinated plan for the social group activity; and
displaying by the unified scaffolded graphical user interface information relating to the coordinated plan,
wherein the state model and the data model are updated in real-time and control display of the real-time group coordination state information by the first, second, third, and fourth panels of the unified scaffolded graphical user interface, the state model (i) tracking and managing one or more changes relating to a group coordination conversation, (ii) managing the data model, and (iii) maintaining the unified scaffolded graphical interface in a consistent and known state, the data model storing and retrieving data relating to the group coordination conversation,
wherein said first panel, said second panel, and said fourth panel are each accessible from said third panel by the plurality of users when the group coordination conversation occurs in said third panel, and wherein results of coordination activities undertaken by the plurality of users in said first panel, said second panel, and said fourth panel are displayed in and accessible from said third panel during the group coordination conversation in said third panel,
wherein the plurality of modes comprises a first mode enabling each of the plurality of users to generate one or more proposed start times,
wherein the first mode comprises step of enabling each of the plurality of users to select one of a plurality of voting buttons associated with each of the one or more proposed start times,
wherein the plurality of voting buttons comprise a thumbs up symbol, a thumbs down symbol, and a prohibition button,
wherein the plurality of modes comprises a second mode for sharing an availability of each of the plurality of users,
wherein the second mode comprises step of enabling the user to select a date and a condition comprising a minimum amount of users with overlapping times of availability to attend the social group activity, wherein each user of the plurality of users indicates a time availability during the selected date,
wherein a time set for the social group activity comprises the earliest time that the minimum amount of users can attend,
wherein the plurality of modes comprises a third mode for generating a poll,
wherein the third mode comprises step of enabling the user to propose one or more dates for the social group activity, each date comprising one or more proposed times,
wherein the user sets one of the proposed times as a selected time for the social group activity, and
wherein the proposed start time comprises a date and a time.
